(19) United States
(12) Patent Application Publication
(10) Pub. No.: US 2013/0024252 A1
(43) Pub. Date: Jan. 24, 2013

(54) Systems and Methods for Monetizing Recyclable Plastics

(71) Applicants: Jeremy David Sicklick, Palos Verdes Estates, CA (US); Eran Conforty, Rancho Palos Verdes, CA (US)

(72) Inventors: Jeremy David Sicklick, Palos Verdes Estates, CA (US); Eran Conforty, Rancho Palos Verdes, CA (US)

(21) Appl. No.: 13/195,783

(22) Filed: Aug. 1, 2011

Related U.S. Application Data
(63) Continuation-in-part of application No. 13/185,480, filed on Jul. 18, 2011.

(51) Int. Cl. G06Q 50/00; G06Q 30/00; G06Q 40/00

(52) U.S. Cl. 705/14.4; 705/308; 705/39

(57) ABSTRACT

The present invention relates to systems and method for monetization of recyclable plastics. Such systems includes a receptacle for receiving fungitized plastics, such as plastic ingots. The fungitized plastic can have a standardized form with a known value that is readily exchangeable for credit, discounts, or currency. Sensors are capable of identifying the fungitized plastic as substantially comporting to the standardized form, thereby confirming the plastic's composition, and weight/size in order to facilitate sorting and proper crediting for its value. The sensors can also identify fungitized plastics that do not match these standards, which are considered counterfeits and are returned to the user. A sorter collects all the identified fungitized plastic of a particular composition together with other plastic of similar composition. Similarly, a crediting system may reward the user for depositing the identified fungitized plastic. The reward may include printing out promotions or vouchers, credits applied to a debit or credit card via a magnetic card reader, applying credit via a mobile phone application, or an account linked to the user credited with currency or points.

### CROSS REFERENCE TO RELATED APPLICATIONS

This is a continuation-in-part of co-pending U.S. application Ser. No. 13/185,480 filed on Jul. 18, 2011, entitled “Systems and Methods for Fungible Densification of Recyclable Plastics”, which is hereby fully incorporated by reference.

### BACKGROUND

This invention relates generally to handling of plastics prior to recycling. More specifically, the present invention relates to a machine for the monetization of recyclable plastics. In some embodiments, the plastics are provided as a standardized plastic coin or ingot which may be received by a monetization apparatus and credit, promotions or currency may be provided in exchange.

The market for plastics has continued to grow, and touches our daily lives in every form from packaging to direct use. The rapid pace at which the plastics market has grown creates a situation where there is an opportunity to better collect and capture the value from plastics packaging before it is discarded and sent to our landfills. The following facts highlight the need as of 2010:
30M tons of plastic is generated per year in US
Only a 7% recycle rate of plastics
And this problem is growing. Plastics are growing faster than recycle rate in US and across the globe

Despite the inherent difficulties and low adoption rates for recycling plastics, there is a great economic and environmental need to do so. Plastics are generally derived from petrochemicals. As such, increases in oil commodity prices have a substantial impact upon the cost to manufacture new plastics. As oil prices are expected to rise as oil supplies are diminished, the cost of new plastic materials is expected to also increase. Over the past two years (2009-2010), the value of recyclable plastics has climbed by 20 percent thereby highlighting 1) the effects of demand outstripping supply for recyclable plastics, and 2) impact of oil as a key input.

Additionally, there is an enormous environmental impact of waste plastic. Plastics exist nearly indefinitely when disposed of Often plastics are in the form of bags or containers. These plastics are relatively light compared to surface area, and can be blown from landfills and contribute substantially to marine pollution. Marine animals often ingest plastics, and plastics form massive floating “garbage patches” in the oceans. Recycling of plastics dampens the wild swings of plastic prices caused by oil price fluctuations. Recycling also keeps these plastics out of our waste streams, thereby reducing pollution, and in particular marine pollution.

Despite these good reasons for recycling plastic materials, plastics are recycled at a much lower rate than other recyclable materials. For example, in 2005, about 80% of newspaper material was recycled, and 70% of corrugated fiberboard was recycled, and yet only 27% of plastic bottles were recycled (and only 7% of all recyclable plastics were recycled). This low recycling rate can be attributed to a number of factors, including lack of knowledge about which plastics may be recycled, habit, and very low density of recyclable plastics. Knowledge and habits may be addressed through education of the consumer, but plastic recycling standards to create financial incentives around fungible units of trade and density cannot be so readily addressed.

There are 5 major barriers to increasing recycling today:
Complex—There are 7 major streams of plastics making sorting complex (for both machines and by hand). Separating 7 different streams of plastic is too cumbersome and too complicated for even the most die-hard recyclers
Dirty—consumers who recycle often do not get weekly pickup (often bi-weekly), or cannot make it to the recycling center weekly. The recyclables start to smell as bad as trash, but are on a less frequent pickup/delivery schedule
No/little financial incentives to recycle—either consumers pay for the trash company to pick up their recyclables, or there is very little incentive and lack of clarity around how much you will get for the recyclables as there is no fungible unit of value
Ineffective recovery—the current sorting technology excludes many types of plastics from being recycled such as black plastics and thin films and redirects them to the landfill, even if consumers had put them in the recycle bin
Low density to value—taking up space in recovery vehicles and landfills

Given these barriers, it is understandable why the recycling rate for plastics is so low in the US, and has not improved with time, despite the public outcry on this topic.

Density of the recyclable material has a large impact on recycle rates. Paper products are the most widely recycled products and have a high density. Aluminum cans are readily compressed at home and are recycled at a lower rate than paper materials, but at nearly double the rates of plastics. Conversely, plastic bottles and shopping bags are not easily compressed. An entire 13 gallon garbage bag filled with plastic bottles weighs only a few ounces. Transporting plastics bottles to a recycling center is burdensome on a consumer. Even when home recycling is available, a consumer may be hesitant to fill up their recycling container with bulky plastics.

Further, the low density of plastics makes recycling less economical for waste companies due to transportation inefficiencies. Although most waste management transportation trucks include mechanical compressors capable of crushing the plastics to a more dense state, plastics tend to be highly elastic and, even when compressed, tend to resist densification.

The ability to densify plastics by the consumer would have a number of benefits: 1) it would reduce the cost of transportation of plastic materials from the consumer to a recycling plant, 2) it would promote increased recycling rates of plastic materials, and 3) it would enable a more effective monetization of recycled plastic materials.

However, mere densification, while increasing recycle rates, is insufficient to substantially promote consumer recycling. In order to do so, the densified plastic must be made a fungible commodity. Once fungitized ingots of highly densified plastics are available, they may be monetized by systems which receive the ingots and exchanges them for credit, promotions, currency or other commodity.

The prior art has failed to recognize the problems associated with recycling plastic in a manner that is enticing and financially rewarding to a consumer, waste management company and recycler, that will enable recycling rates to improve. Given the lack of effective solutions, it is understandable why plastics recycling have only achieved a 7% rate in United States.

It is therefore apparent that an urgent need exists for systems and methods for monetization of recyclable plastics. Such systems and methods would increase recycling rates of plastics by creating financial incentives/standards for consumers and reducing transportation costs of plastics to recycling facilities, and costly processing and handling.

### SUMMARY

To achieve the foregoing and in accordance with the present invention, systems and methods for monetization of recyclable plastics is provided. Such systems and methods enable reduced cost of transporting plastics for recycling, greater recycling compliance, and commoditization of plastic recycling through the creation of a marketplace for fungible plastic ingots.

Some embodiments of the systems and methods for monetization of recyclable plastics include a receptacle that can receive fungitized plastics. The fungitized plastic can have a standardized form with a known value that is readily exchangeable for credit, discounts, or currency. In some embodiments the fungitized plastic may be in the form of ingots or coins. These coins may be sized and shaped according to their composition. Further these sizes are known standards, so the value and composition of the coins may be readily ascertained.

The system may also include one or more sensors capable of identifying the fungitized plastic or coin as substantially comporting to the standardized form. These sensors may include size sensors, optical sensors, weight sensors, or any other applicable sensor type. The sensors confirm the plastic's composition, and weight/size in order to facilitate sorting and proper crediting for its value. The sensors can also identify coins or other fungitized plastics that do not match these standards. These are identified as counterfeits and may be returned to the user.

A sorter collects all the identified fungitized plastic of a particular composition together with other plastic of similar composition. Similarly, a crediting system may reward the user for depositing the identified fungitized plastic. The reward may include printing out promotions or vouchers. Alternatively, credits may be applied to a debit or credit card via a magnetic card reader. Alternatively, an account linked to the user may be credited with currency or points. An application on a smart phone may interface with the system, in some embodiments, in order to manage user accounts. Alternatively, voucher cards tied to the account may be utilized to ensure the credits are properly rewarded.

In some embodiments, the system may include a network adapter that enables the system to communicate with a server system. This communication can be used to identify when credits are applied to an account in order to minimize the chances that a user can fraudulently hack their account. Additionally, user activity can be tracked for loyalty programs, etc. In some embodiments, the system may also include a solar array in order to produce energy.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an isometric frontal view of a recyclable plastics densification apparatus, in accordance with some embodiments;

FIG. 2 is an isometric rear view of a recyclable plastics densification apparatus, in accordance with some embodiments;

FIG. 3 is a first isometric frontal cutaway view of a recyclable plastics densification apparatus, in accordance with some embodiments;

FIG. 4 is an isometric rear cutaway view of a recyclable plastics densification apparatus, in accordance with some embodiments;

FIG. 5 is a second isometric frontal cutaway view of a recyclable plastics densification apparatus, in accordance with some embodiments;

FIGS. 6 and 7 are isometric frontal views of a recyclable plastics densification apparatus with an open lid, in accordance with some embodiments;

FIG. 8 is a direct side cutaway view of a recyclable plastics densification apparatus, in accordance with some embodiments;

FIG. 9 is a direct rear cutaway view of a recyclable plastics densification apparatus, in accordance with some embodiments;

FIGS. 10 to 16 are a direct side cutaway views of a recyclable plastics densification apparatus in operation, in accordance with some embodiments;

FIG. 17 is an example flow chart illustrating a method for the densification of recyclable plastics, in accordance with some embodiments;

FIG. 18 is an isometric frontal view of a recyclable plastics monetization apparatus, in accordance with some embodiments;

FIGS. 19 to 22 are isometric rear cutaway views of the recyclable plastics monetization apparatus illustrating example sorting positions, in accordance with some embodiments;

FIGS. 23 and 24 are isometric views of the receiving unit of the recyclable plastics monetization apparatus, in accordance with some embodiments;

FIGS. 25 to 27 are isometric views of the receiving unit in conjunction with a fungitized plastic coin at various stages of sorting, in accordance with some embodiments;

FIGS. 28 to 32 are side cutaway views of the receiving unit in conjunction with a fungitized plastic coin at various stages of sorting, in accordance with some embodiments;

FIG. 33 is a rear isometric view of the interior of the recyclable plastics monetization apparatus in conjunction with a fungitized plastic coin, in accordance with some embodiments;

FIG. 34 is a rear isometric view of the interior of the recyclable plastics monetization apparatus where a fungitized plastic coin is being rejected, in accordance with some embodiments;

FIG. 35 is a front isometric view of the recyclable plastics monetization apparatus with the door open, in accordance with some embodiments;

FIG. 36 is a front isometric view of another embodiment of the recyclable plastics monetization apparatus, in accordance with some embodiments; and

FIG. 37 is an example flow chart illustrating a method for the monetization of recyclable plastics, in accordance with some embodiments.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for the monetization of recyclable plastics. As previously noted, plastics, in the form of bags and bottles, are generally not very dense due to trapping of air and elasticity of the product in the shape in which it was molded. Systems have been developed which are capable of densifying these plastics and forming standardized ingots or coins. These ingots and coins may then be deposited in centralized collection systems that reward the user for depositing the coins with credit, promotions or currency. This produces a market for the coins, effectively monetizing them and therefore promoting increased recycling.

One important aspect of disclosed embodiments is the ability for the plastics monetization system to be readily usable by average consumers. In order to achieve this level of consumer orientation, a number of user friendly features and have been incorporated into the system. These may include easy operation, semi or fully automated sorting of plastic coins of differing value and user friendly interfaces. Additionally, such a system may be enabled to validate the coins, thereby reducing the opportunity of fraud and providing security to the plastic coin market. These and other features will be discussed in greater detail below.

Note that the following discussion is presented in two subsections including separate titles. While these subsections are provided as a means of clarity, it should be understood that content found within any one subsection may be readily applied to another section as is reasonable. Subsections are thus not intended to limit the scope of the present invention in any way.

The first subsection will discuss systems and methods for the generation of standardized and fungible plastic coins or ingots. This discussion will center on residential consumer appliances; however, it is equally possible that such systems may be designed for a central collection location, such as a supermarket for example. The second section is directed toward monetization systems which can convert the generated ingots into credit, currency, or promotions. Such systems may be more suited for centralized collection rather than in-home use. In some embodiments, the densification system disclosed in the first section may be integrated into a monetization system as disclosed in the second section. Such a hybrid type system could potentially accept either plastic ingots or recyclable bottles and other raw plastic for conversion into credit.

I. Plastics Densification and Fungitization System and Methods

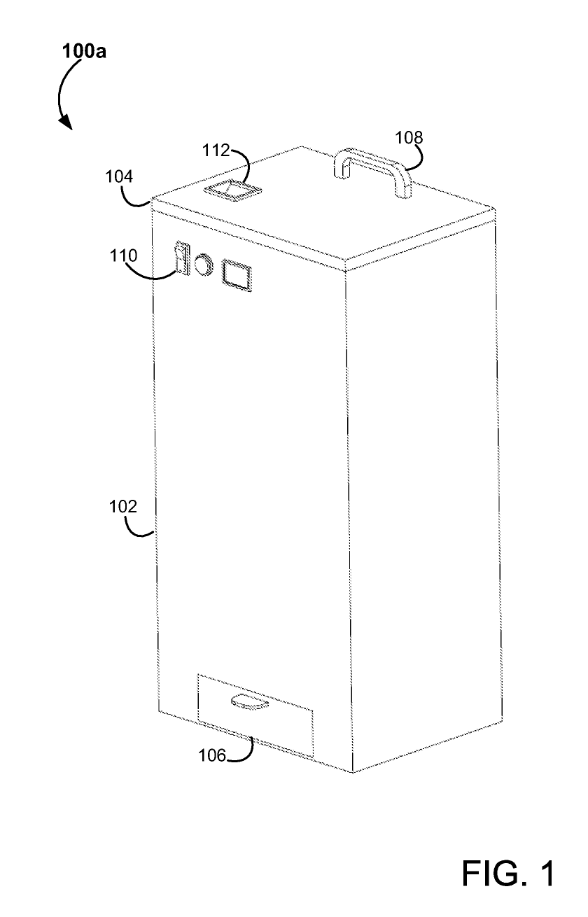

To facilitate the discussion, FIG. 1 is an isometric frontal view 100a of an embodiment of the recyclable plastics densification apparatus (hereafter “densification apparatus”), in accordance with some embodiments. Note, that while specific forms and designs of the present densification apparatus are provided, these design choices are not considered particularly crucial to the overall utility of the apparatus; thus, modifications of form or design to accommodate aesthetics, location of use (e.g., a wall mounted variation), or regulatory compliance is considered within the scope of this disclosure. Further, while many parts of the densification apparatus are described as being manufactured from plastic, metals, ceramics or other durable materials, it is understood that any functional material substitution is considered within the scope of this disclosure.

In this example figure, the exterior of the densification apparatus is illustrated. The densification apparatus includes an external housing 102 and a lid 104. A handle 108 couples to the lid 104 in order to access the interior of the densification apparatus. In some embodiments, the lid 104 may be opened by a foot pedal, or automatically (e.g., using IR sensors). Additionally, the densification apparatus includes a dispenser 106 for collection of the densified plastic after operation.

A set of controls 110 may also be included on the densification apparatus for operation. The controls 110 may be found on the external housing 102, as illustrated, or on the lid 104, in some embodiments. Typically, the controls 110 include an on/off switch, display and cycling switch. In some alternate embodiments, the cycling switch may be omitted and internal sensors may measure if plastic material has been deposited within the densification apparatus. In these embodiments, the densification apparatus may cycle after the lid has been closed. The controls 110 may also include an emergency shutoff switch for added safety. Further, the entire unit may include a tilt sensor that automatically shuts off the system when it has been tipped over. The tilt sensor may be a bottom switch, accelerometer or any other directional finder.

Additionally, in some embodiments, the controls 110 may also include a plastic bag receiving switch which initiates a vacuum at port (not illustrated) which sucks in thin film plastic bags. The vacuum port may be directly available when the lid is opened, or may be accessible from the exterior of the system.

Additionally, a scanner 112 is seen in this embodiment, and can be an optical scanner such as a barcode scanner. The scanner 112 may be utilized by the user to identify the type of plastic composition a container has prior to it being densified and converted into a fungible asset. Most commercial containers include standardized identifiers such as QR codes or UPC barcodes. In this example, these barcodes may be compared to an internal database for determination of composition. The database may, in some embodiments, be periodically updated through firmware updates, or even by wireless connectivity. Alternatively, standardized barcodes may be adopted by the manufacturing sector which includes material data; the barcode reader may gather composition from scanning these standardized barcodes.

By determining the composition of the material being recycled, the system is capable of adjusting process conditions such as heating temperature and time. Further, the final product generated may be marked or manufactured to indicate the composition. Although not illustrated in the following examples, some systems may include more than one compressive cylinder, and may therefore generate streams of recyclable plastics that are of pure compositions (as opposed to mixed plastic output).

Alternatively, some embodiments may include a number of sized holes once the lid is opened in order to manually sort the plastics. One such hole may be for plastic bags and films which are commonly polyethylene (PE). A second hole may be sized for beverage bottles, such as bottled water and soda. These containers are generally manufactured from Polyethylene Terephthalate (PET). Lastly there may be a general waste space for remaining mixed plastics.

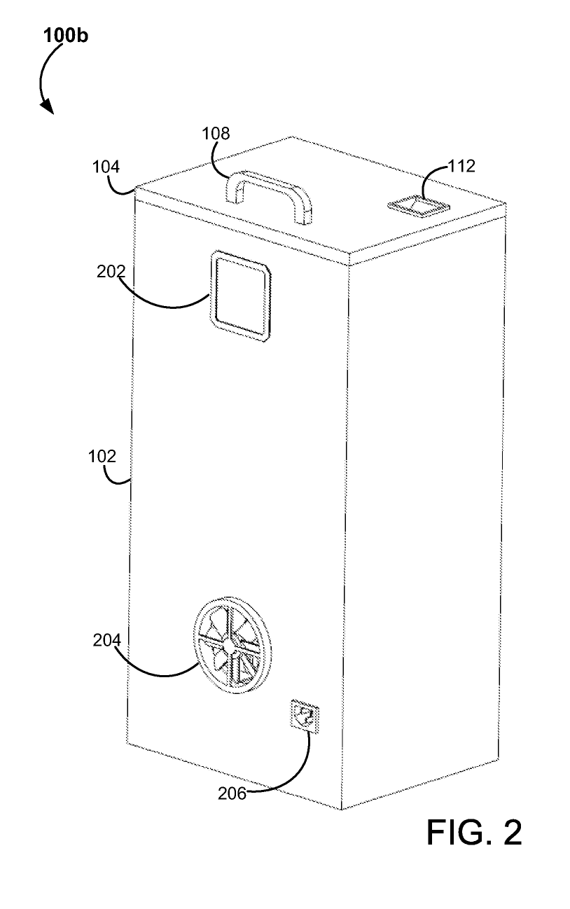

FIG. 2 is an isometric rear view 100b of the recyclable plastics densification apparatus, in accordance with some embodiments. On the rear of the densification apparatus may be a power cord adapter 206 and a fan 204. As heat is utilized in many embodiments to densify the plastics, the fan 204 may provide cooling to internal electronics and components. Further, the fan may help prevent the venting of harmful gas or odors. The fan may force air into the system, which then is forced out through a filter 202. The filter may be a HEPA filter, active charcoal filter, or other filter type designed to reduce harmful gas and odor.

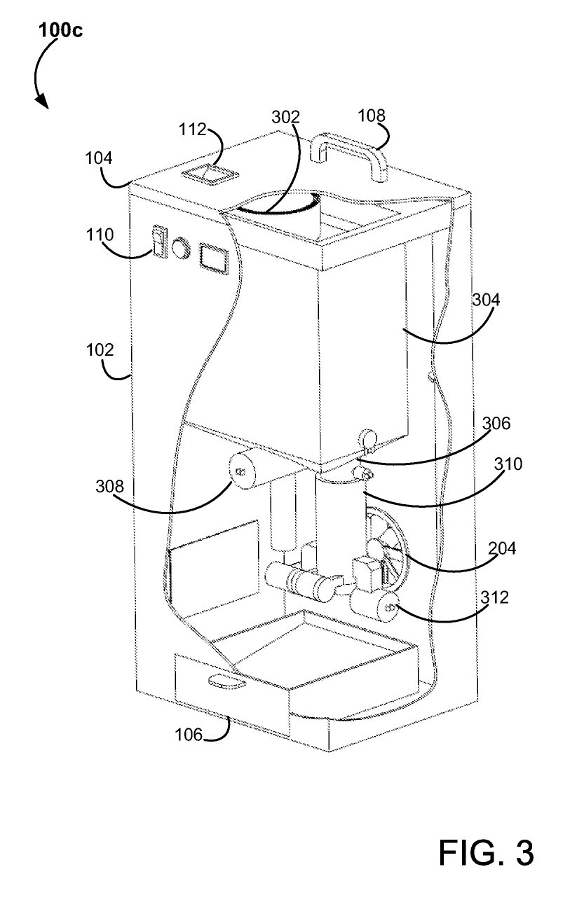

FIG. 3 is a first isometric frontal cutaway view 100c of the recyclable plastics densification apparatus, in accordance with some embodiments. This cutaway view provides an illustration of many of the internal components of the densification apparatus. Logic controllers, other electronics, fasteners and structural supports have been largely omitted from this illustration in order to not unnecessarily crowd the figure, and thereby increase clarity.

In addition to the computer systems which operate the system, some embodiments may further include a wireless antenna and control logic. Including a wireless communication system provides a few distinct benefits. These include being able to update composition databases (useful when the system is outfitted with a barcode reader). Further the wireless communicator may send operational data to a data center via the internet or other suitable network. Operational data may be useful in troubleshooting the unit if it requires repairs, and further may be utilized to keep track of the number and type of fungible plastic ingots produced by each machine. This data may be utilized to prevent counterfeit ingots from being produced, and ensures fidelity in the market.

In the example illustration, the external housing 102 and lid 104 have been made partially transparent to show a hopper 304. A depressor 302 coupled to the lid 104 can press on a compression plate within the hopper 304 in order to push plastic materials down, in some embodiments. The depressor 302, which pushes plastics toward the grinders, may be driven by springs, pneumatics, or by motor.

Coupled to the hopper 304 is a conveyer 308 which transports the plastics to a compressive cylinder 306. Around the compressive cylinder 306 is a cylinder wrap 310. The cylinder wrap 310 may include both a thermal blanket and an insulating layer. The thermal blanket may include heating coils which are configured to heat the compressive cylinder 306 to a temperature required to melt at least one component of the incoming plastic. In alternate embodiments, the cylinder wrap 310 may include only an insulating layer and the heat for melting the plastic may be supplied by superheated air blown over/through the plastic for a set period of time.

In some embodiments, the compressive cylinder 306 may include a thermocouple or other suitable device for modulating temperature. In some alternate embodiments, the densification apparatus may be pre-calibrated to reach the desired threshold temperature without the need for temperature feedback.

The insulating layer reduces the amount of heat lost from the compressive cylinder 306 to the other internal systems. However, no matter how good the insulation layer is, some heat is lost. In some embodiments, the amount of heat lost is minimal and will dissipate without any issues. In some alternate embodiments, such as that illustrated presently, the fan 204 may increase airflow around the compressive cylinder 306 in order to reduce excess heat. Additionally, the fan 204 may be integrated into an air filtering system. The melting of plastics is prone to generation of volatile gasses. These gasses are unpleasant to smell, and may pose a health risk. The densification apparatus may be manufactured to airtight specifications to minimize the amount of gasses which escape. However, some gas is likely to escape the compressive cylinder 306, so a pressure gradient in the system generated by the fan 204 may force any escaped gas through a filter 202, such as a HEPA filter, carbon filter, or other suitable filter, to remove these smells and/or harmful gasses/particulates prior to venting to the environment.

The hopper 304, conveyer 308 and compressive cylinder 306 should be made from suitably durable materials. In the case of the compressive cylinder 306, the materials must also be heat resistant, and not readily bound by melted plastics, in some embodiments. Thus, the hopper 304 and conveyer 308 may be manufactured from any combination of metals, plastics, ceramics or any other suitable materials. The compressive cylinder 306 may likewise be made of metal, ceramics, or other suitable material (such as high temperature resistant resins). In some embodiments, the compressive cylinder 306 may include a heat conductive metal with the interior coated with Teflon®, chrome plated, or other suitable non-stick surface.

The bottom of the compressive cylinder 306 may hinge open, as will be discussed in greater detail below. One or more locks 312 may lock the hinged bottom in place during operation as the densification of the plastics requires increased pressure.

The dispenser 106, in this embodiment, is illustrated as a pull out drawer. The dispenser 106 provides a place for the densified plastic to cool prior to being accessed by the user. While the drawer style design is easily locked until the plastic may be handled by the user, other systems are equally suitable for the dispenser 106, such as a conveyer system or a magazine that collects the ingots or coins and can be removed and used as a coin carrying device to the collection facility. Also note that the fan 204, in some embodiments, may be used not only to assist in cooling the compressive cylinder 306 and reducing internal temperatures, but also assists in cooling the densified plastic ingot to a touchable temperature.

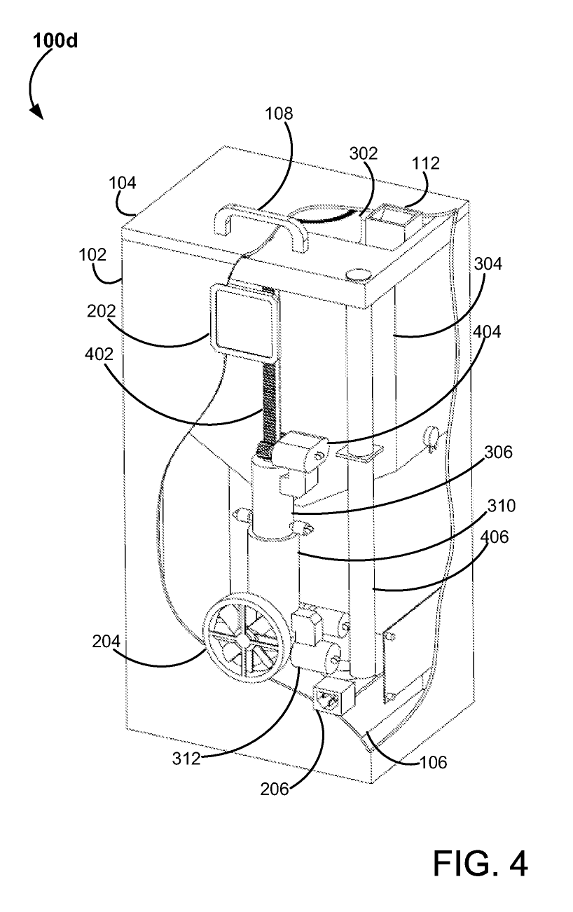

FIG. 4 is an isometric rear cutaway view 100d of the recyclable plastics densification apparatus, in accordance with some embodiments. Many of the same elements are visible in this example embodiment. In addition, however, a piston 402 is visible engaging the compressive cylinder 306. The piston 402 may be actuated by a motor driver 404 in some embodiments. Alternatively, the piston 402 may be driven by pneumatics in some alternate embodiments. The piston 402 depresses into the compressive cylinder 306 in order to compress the melted plastics into the ingot.

Lastly, in this embodiment, the lid 104 is supported by two rods 406, thereby allowing for vertical opening and closing of the lid 104. This is a design consideration as it allows the depressor 302 and compressive plate to be lowered into the hopper 304 vertically which has some advantages. However, it is equally possible that the lid 104 is hinged, in some embodiments. In either case, an electrical circuit for the operation of the system may be routed through the lid 104, thus unless the lid 104 is closed, the unit will not be operable.

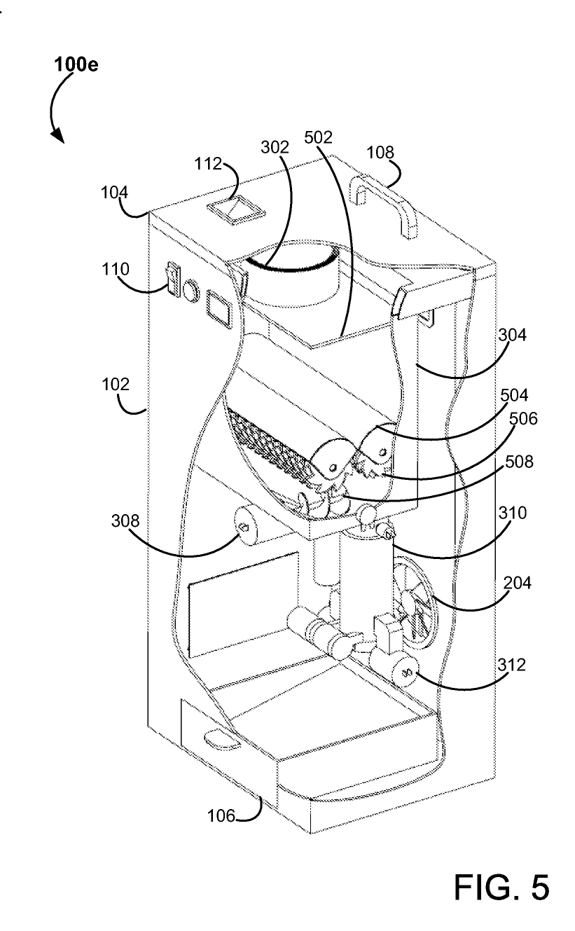

FIG. 5 is a second isometric frontal cutaway view 100e of the recyclable plastics densification apparatus, in accordance with some embodiments. This visual differs from the past cutaways in that the hopper 304 is also semi-transparent in order to illustrate the interior of the hopper 304 including the compressive plate 502 coupled to the depressor 302, and the shredders 506 at the bottom of the hopper 304. A shield 504 covers the shredders 506 when not in operation in order to prevent inadvertent injury by the user. The shredders 506 illustrated here are rotary style grinders; however alternate shredder designs are well known and may be incorporated where suitable.

Plastics placed within the hopper 304 are ground by the shredders 506 and transported by the conveyer 308 to the compressive cylinder 306 for melting and compression. The conveyer 308 may include any conveyer type system, however here an auger 508 is illustrated as moving the ground plastic particles to the compressive cylinder 306. An auger 508 has two advantages: 1) it provides a seal between the compressive cylinder 306 and fan 204, which minimizes the volatile gasses generated during melting from flowing up and out through the hopper 304; 2) the amount of ground plastics entering the compressive cylinder 306 may be tightly controlled. It is important that the proper amount of plastic is incorporated into each plastic ingot in order to make them fungible. Furthermore, the amount of heat, mold size and pressure required to generate an ingot is dependent upon amount of plastic, thus metering out a consistent level of plastic grinds is important.

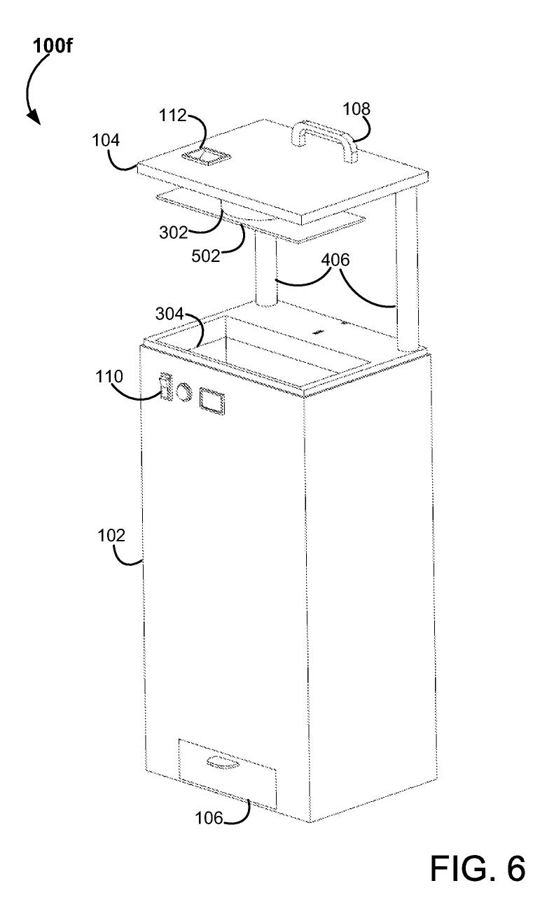

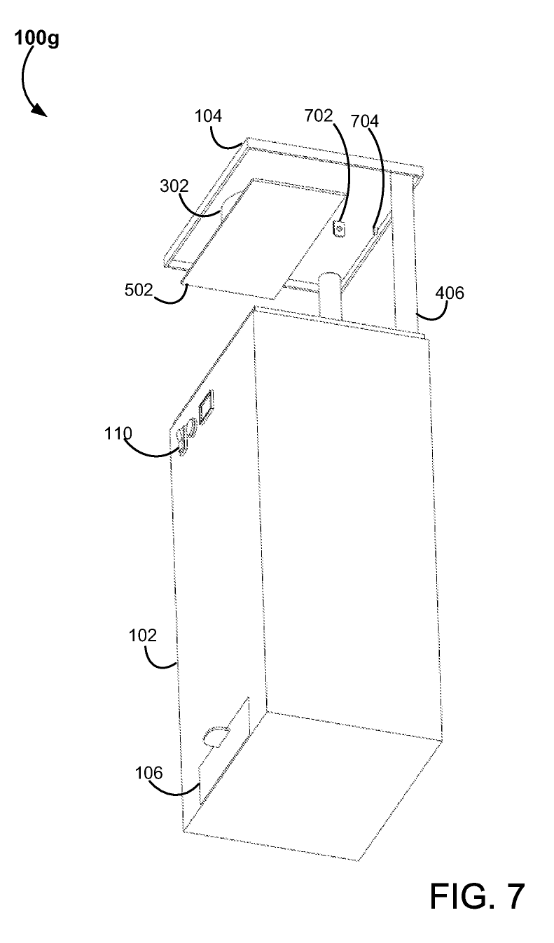

FIGS. 6 and 7 are isometric frontal views, 100f and 100g respectively, of the recyclable plastics densification apparatus with an open lid, in accordance with some embodiments. As discussed previously, in this example embodiment, the lid 104 opens vertically on the rods 406. The depressor 302 and compressive plate 502 are coupled to the lid 104 enabling a tight fit on the compressive plate 502 within the hopper 304 when the lid is closed. Alternate designs, such as hinged lid 104, a hole for insertion of the plastic bottle with a flap covering, or any other suitable system are considered within the scope of this disclosure.

The bottom view 700 of the densification apparatus also illustrates important safety features including a latch 702 and sensor 704. While the lid 104 is open, the shredders 506 are inoperative and the shield 504 is covering the shredders 506 due to feedback from the sensor 704 (the sensor may alternatively include a circuit breaker type design with electricity flowing through the lid in order to be operable). This prevents inadvertent mangling of a person's hand when the lid 104 is open. When the lid 104 is closed and a cycle is started, the latch 702 locks the lid 104 closed in order to ensure the cycle is not disrupted and for safety purposes. The latch 702 may be driven by any actuator type, such as motor or solenoid.

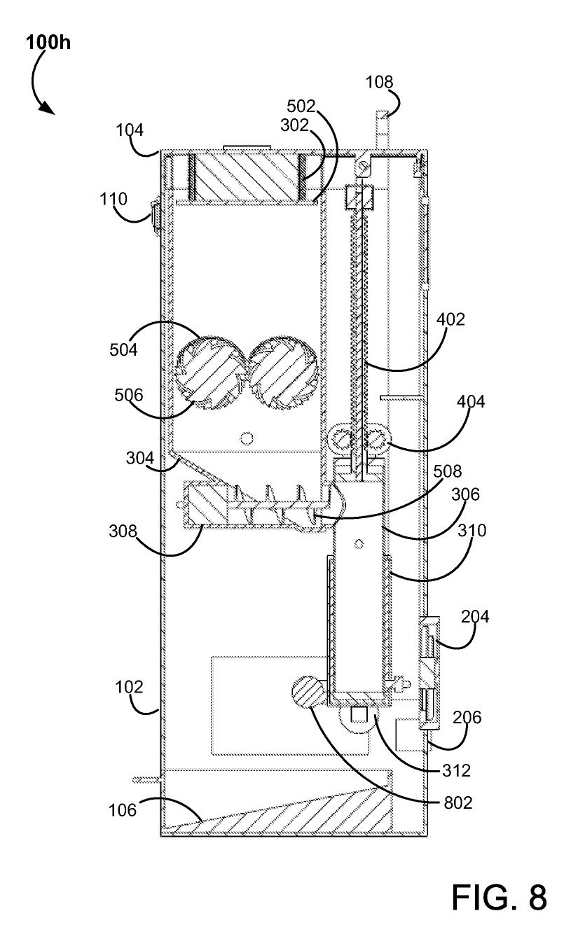

FIG. 8 is a direct side cutaway view 100h of the recyclable plastics densification apparatus, in accordance with some embodiments. This cutaway view provides a clear image of each functional portion of the densification apparatus. Further, this illustration provides a view of the interior of the compressive cylinder 306. The plastic is placed within the hopper 304 by opening the lid 104. The shredders 506 engage in order to grind the plastic material into shreds for increased melting and compressibility. The ground plastic is accumulated under the shredders 506 within the hopper 304. In some embodiments, the hopper may include an optical sensor which identifies bottle materials (PET) by shape or optical absorbance. This data may be utilized in order to tailor heating within the compressive cylinder, in some embodiments.

A level sensor determines when enough ground plastic has been generated to produce an ingot via height or weight of the ground plastic. Once sufficient plastic has accumulated, the auger 508 transports a set amount of the ground plastic to within the compressive cylinder 306.

Plastic bags may be handled in a similar manner. In some embodiments, plastic thin film bags are deposited within the hopper 304 and are ground with other plastic materials. In some embodiments, the thin plastic bags may bind to the shredders 506, so in these embodiments the shredders 506 may periodically reverse in order to disengage the bound plastics. In some alternate embodiments, thin film plastic bags may instead be fed through a port via a vacuum system. These bags may be deposited directly into the compressive cylinder 306, or auger, without grinding. Since the plastic bag material is so thin, these bags do not require grinding before melting and densification. In yet another embodiment, a vacuum port may be located within the hopper 304 below the shredders 506 which engages prior to grinding. This would pull any plastic bags out of the hopper 304 to the compressive cylinder 306 before grinding.

Melting in the compressive cylinder 306 may occur prior to, or simultaneously with compression by the piston 402. Melting temperature may be tightly controlled based upon plastic type being recycled. In a mixed plastic ingot, only the temperature of the lowest melting component is required to be reached in order to bind the ground plastic pieces. Typically, for mixed plastics, melting is performed around 400° Fahrenheit (F), in some embodiments. In alternate embodiments, the melting may be performed at about 270° Fahrenheit. For single composition plastics, different temperatures may be utilized. For example, the melting point of HDPE (High Density Polyethelyne) is about 266° F. The melting point of LDPE (Low Density Polyethelyne) is about 230° F. The melting point of PET (Polyethylene terphthalate) is about 500° F. The melting point of PP (Polypropylene) is about 320° F. The melting point of PS (Polystyrene), EPS (foamed or expanded polystyrene) is about 150-240° F. The melting point of PVC (Polyvinyl Chloride) is about 167-194° F. Too high a melting temperature produces excessive gas byproducts and wastes energy, thus lowest effective melting temperatures are desired.

The compressive by the piston 402 forces the melted or semi melted plastic down into the mold for forming an ingot. In some embodiments, within the bottom interior of the compressive cylinder is a screen or filter which ensures that only plastic materials are allowed into the mold. In some embodiments, this screen filter may be removed for easy cleaning. This ensures that ingots are relatively pure and do not contain undue debris.

After the ingot is formed, the locks 312 may disengage the bottom of the compressive cylinder 306 and the hinge 802 may enable the newly formed ingot to drop down into the dispenser 106. In alternate embodiments, the ingot may be deposited into a magazine, which stacks multiple ingots for easy carrying. The newly formed ingot will be above a handling temperature and will cool prior to being accessed by the user. Generally, any ingot shape or size is possible; however, for a residential system, smaller ingots may be preferred due to recycling volumes.

These ingots may be coin shaped, and may be monetized under some business models. Coins may include embossed identification, including identification of plastic type, sponsors (via, e.g., one or more logos), barcodes, source machine, or the like. Further, coins may have different shapes or sizes to distinguish them. This becomes particularly important where the densification apparatus is not a single stream, as illustrated here, but rather a multiple stream system. For example, while a single hopper 304, conveyer 308 and compressive cylinder 306 is illustrated in these figures for clarification purposes, it is entirely possible that some embodiments of the densification apparatus may include more than one hopper 304. Each hopper 304 may correspond to a particular recyclable material, as indicated by the resin identification code on the bottom of a container. Thus, a single densification apparatus may be capable of producing multiple coin types, each coin corresponding to a particular plastic type.

It is also important to note that the generated ingots of particular size, composition, weight and shape are manufactured to conform to a set of standards. These standards enable the ingots to be fungible, and therefore enable a marketplace for these ingots/coins. A retailer, or recycler, may know the value of any particular ingot based upon its shape or identification, and thus they may be readily traded for credit, currency, or discounts.

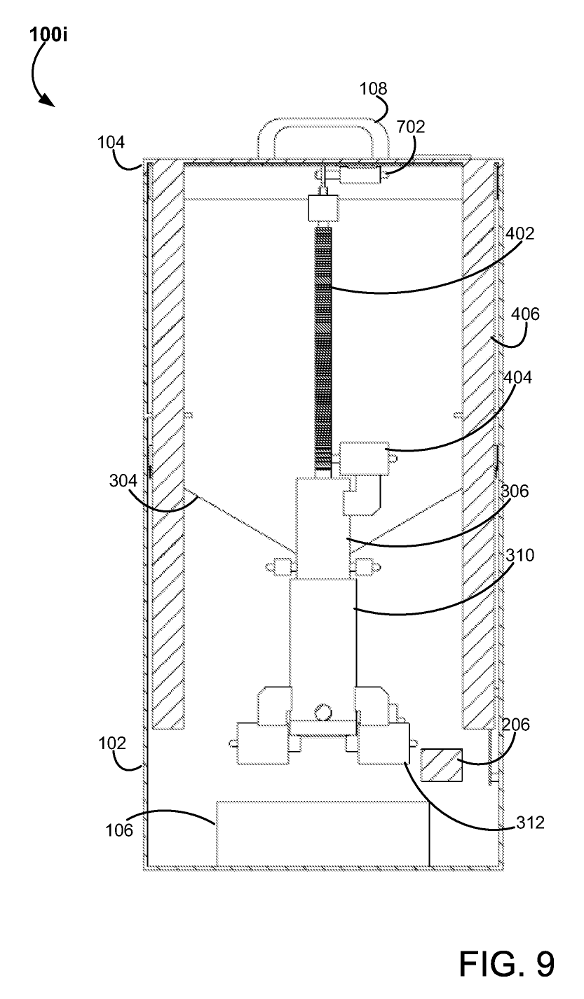

FIG. 9 is a direct rear cutaway view 100i of the recyclable plastics densification apparatus, in accordance with some embodiments. This rear cutaway figure more clearly illustrates the latch 702 identified earlier. A pin coupled to a solenoid may secure the lid 104 shut during unit operation, in this embodiment. Likewise, the locks 312 may be more clearly seen in this illustration. Again, a pin coupled to a solenoid extends underneath the compressive cylinder 306. When the ingot has been formed, the pins may be retracted thereby enabling the bottom of the compressive cylinder 306 to hinge open and release the newly formed ingot.

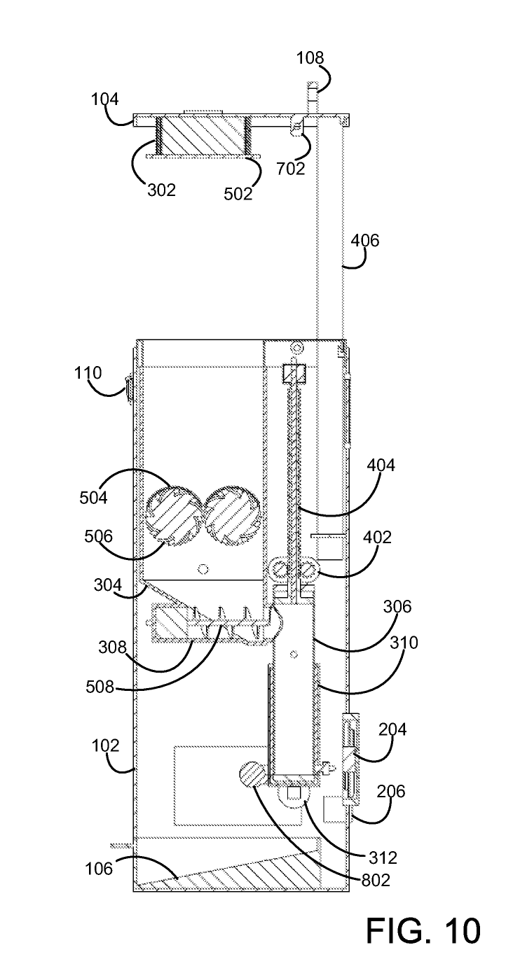

FIGS. 10 to 16 are direct side cutaway views of a recyclable plastics densification apparatus in operation, in accordance with some embodiments. The operation starts with opening the lid 104 as indicated at FIG. 10. When opened the depressor 302 is retracted, thereby holding the compressive plate 502 close to the lid 104 and allowing plastic materials to be inserted into the hopper 304. The shield 504 is closed, thereby making the shredders 506 inaccessible to the user. The lid 104 is then closed, and the latch 702 engages to ensure the lid 104 is not reopened during operation.

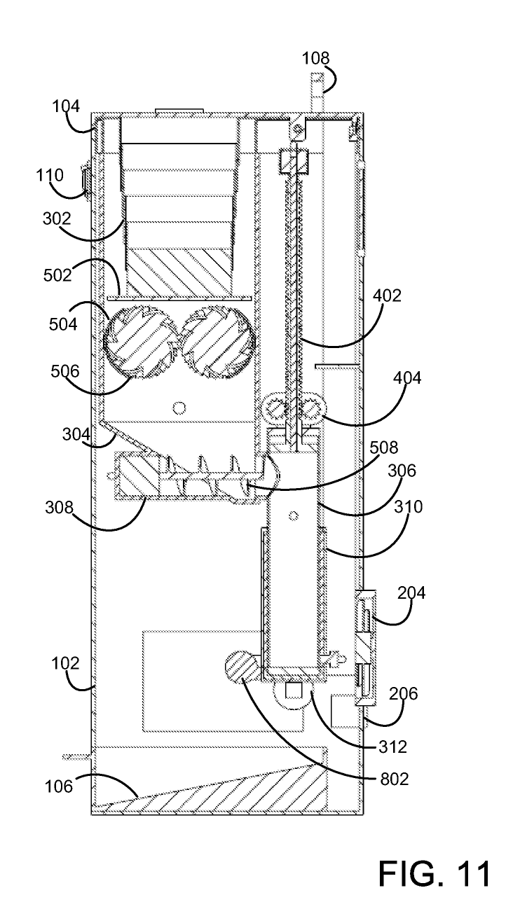

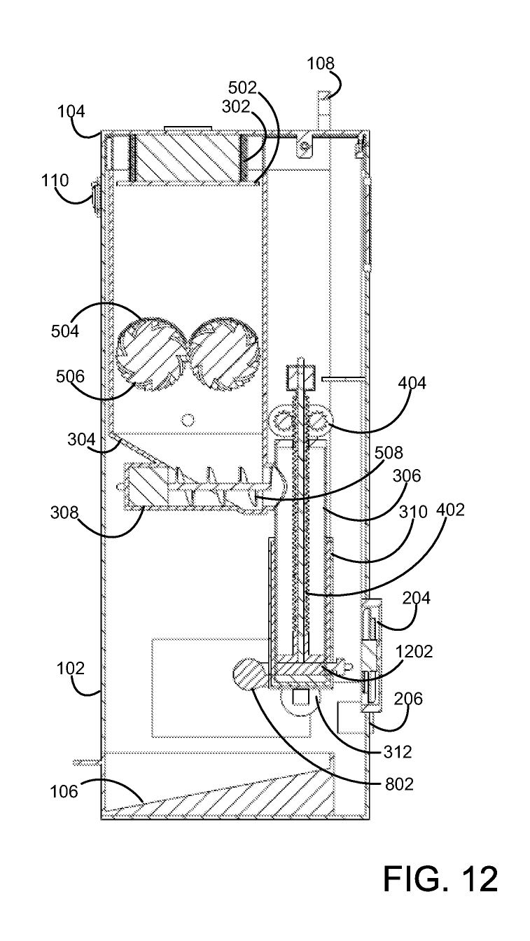

Once the cycle is started, the depressor 302 extends by motor, pneumatic, or springs into the hopper 304, as illustrated in FIG. 11. The depressor 302 forces the compressive plate 502 down against the plastic material, which in turn is forced against the shredders 506 which are now spinning to grind the plastics into shredded plastic material. The shield 504 is retracted from the top of the shredders 506 to allow access of the shredders 506 to the plastic material. Once sufficient material is collected at the bottom of the hopper 304, as measured by a sensor, the auger 508 may transport a set amount of the shredded plastic material into the compressive cylinder 306. The cylinder wrap 310 supplies heat to the compressive cylinder 306 and the driver 404 drives the piston 402 down the length of the compressive cylinder 306 to compress the melted plastic shreds into a coin 1202, as illustrated at FIG. 12. The coin 1202 may be a particular shape, and/or may be embossed with any identification desired, including logos or branding.

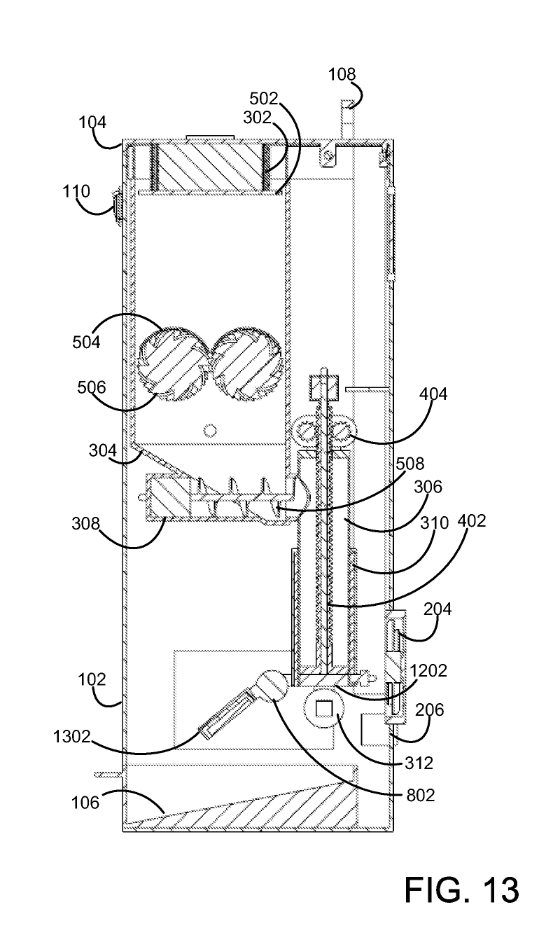

Once the coin 1202 has been formed, it may be held temporarily within the compressive cylinder 306 to partially solidify. Then the pins of the locks 312 may retract thereby enabling the mold 1302 at the bottom of the compressive cylinder 306 to open, as illustrated at FIG. 13. The hinge 802 may include a motor to ensure the mold 1302 opens and closes appropriately.

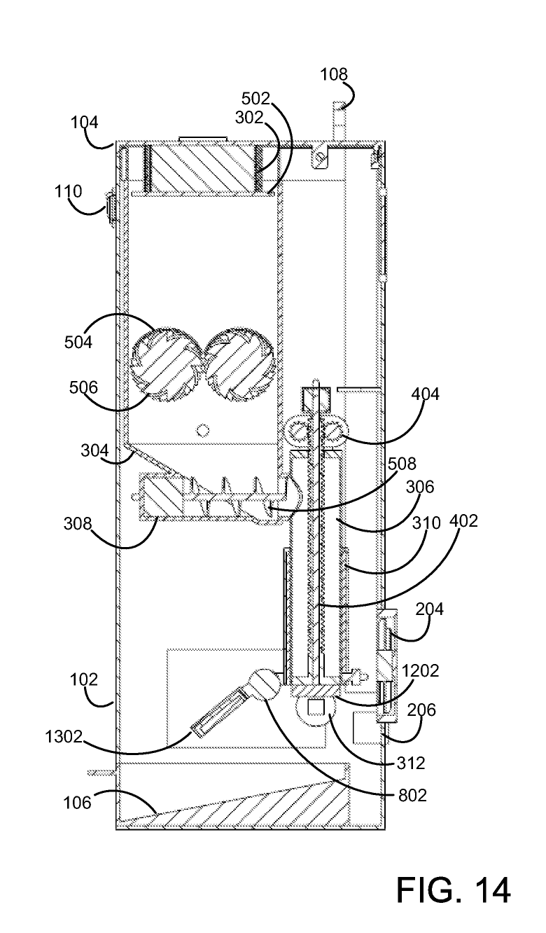

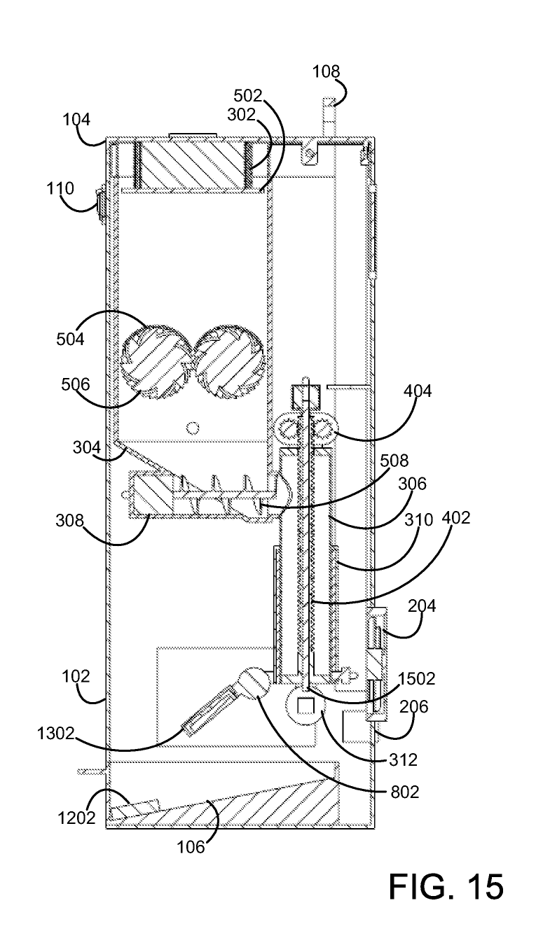

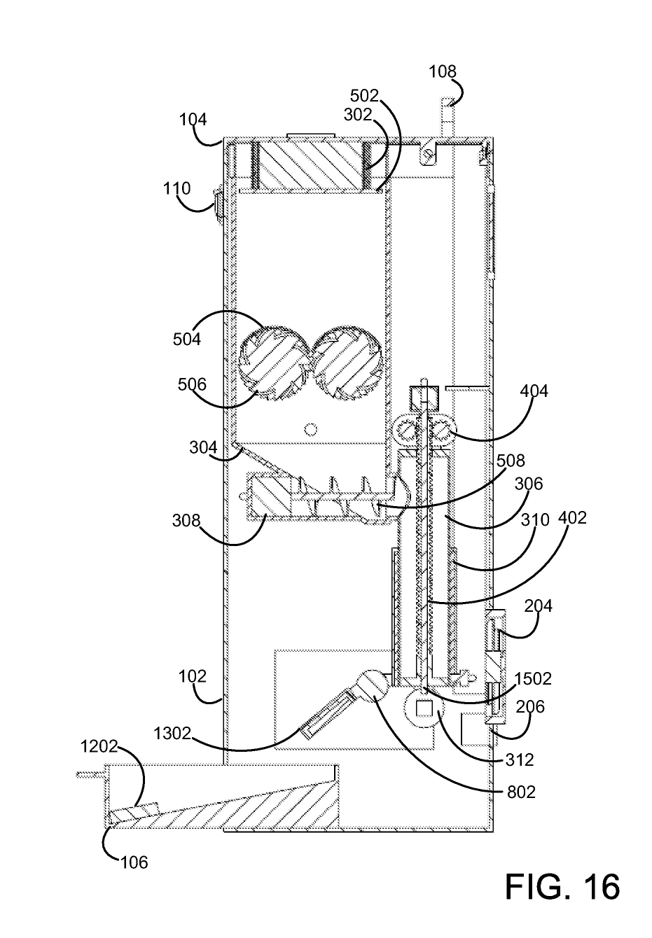

After the mold 1302 is open, the driver 404 may drive the piston 402 further down to press the coin 1202 out of the compressive cylinder 306, as indicated in FIG. 14. Then the coin 1202 may be disengaged from the piston 402 by a pin 1502 which presses on the coin 1202, as indicated at FIG. 15. The coin 1202 then falls into the dispenser 106 where it cools to a temperature at which it can be comfortably handled. Lastly, the dispenser 106 is opened thereby enabling the user to collect the coin 1202, as illustrated at FIG. 16. The piston 402 may then be raised again by the driver 404, the mold 1302 may be closed by the hinge 802, and the locks 312 may again secure the mold 1302 closed for another cycle.

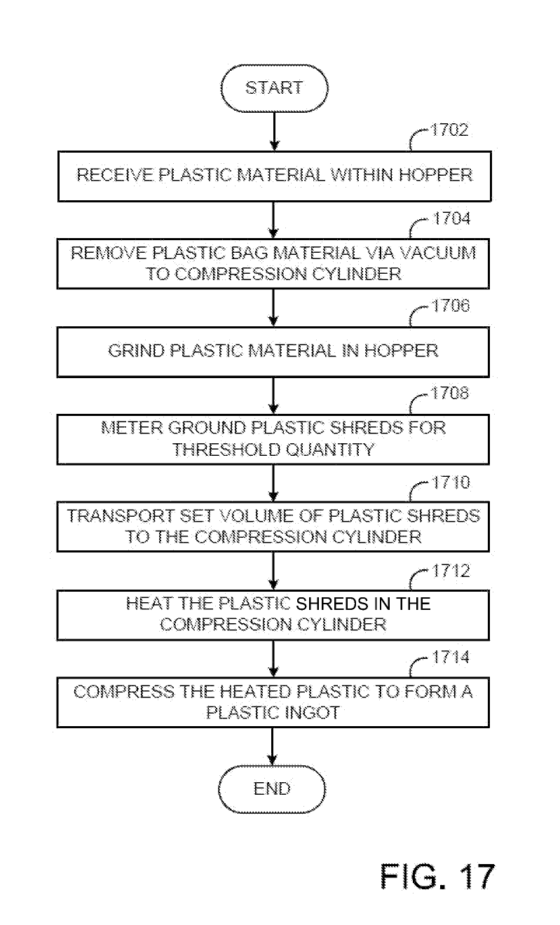

FIG. 17 is an example flow chart illustrating a method for the densification of recyclable plastics, in accordance with some embodiments. This process begins by receiving plastic materials within the hopper (at 1702) as previously discussed. This may include receiving a single species of plastic (segregated by resin identification code) for multiple stream systems, or may include mixed plastics for a single hopper system.

The method continues by optionally segregating plastic bag material from the hopper utilizing a vacuum system (at 1704). This action of separating out thin film plastic bags may be omitted if the shredders have a self cleaning cycle, or if an exterior port exists for receiving plastic bags.

Next the plastic remaining in the hopper may be ground utilizing the shredders (at 1706). Shred size may vary based upon unit size, however generally grind sizing is optimized to reduce power requirements for melting and ensuring adequate compressibility. The level of ground plastic is metered (at 1708) for a threshold level. Once the threshold has been reached, a set amount of the ground plastic may be transported to the compression cylinder (at 1710). This material is then simultaneously heated (at 1712) and compressed (at 1714) in order to generate a plastic ingot or coin. The ingot/coin may be of particular shape, size or be embossed with an identification of material contained within it, source, or other relevant information.

While the present invention has been described in a number of embodiments, there are a number of variations that fall within the scope of this disclosure. For example, while a compressive cylinder with a piston has been detailed in a number of the embodiments, it is also considered that an injection molding type system utilizing an auger where the plastic is melted prior to being injected into a mold may be equally suitable with some embodiments. Likewise, while heating coils driven by electrical current are disclosed, heat may be equally supplied by superheated air, or combustion systems.

In addition, in some embodiments a consumable HDPE or other lower melting temperature plastic may be supplied to the system. This consumable binder material may be maintained in a melted state and injected into the mold with the compressed ground plastic in order to bind the ingot. The advantage of this system is that the melting temperature of the binder may be lower than the ground plastic, and the system does not need to heat significantly for each ingot. Likewise, in yet other embodiments, the binder may even include a solvent, resin, or non-heated monomer solution which polymerizes once in the mold.

In some alternate embodiments, the plastic shreds may be compressed without heating. These compressed shredding may be sealed within a canister or other container and deposited at a central collection location. In some embodiments, canisters may be emptied at the collection point and returned to the user for re-use. Additionally, the user may receive a payment for the canister, thereby incentivizing the recycling.

II. Plastics Monetization System and Methods

Now that the densification of plastics has been readily disclosed in terms of a number of alternate embodiments, the discussion will be directed to post densification activity in order to monetize the plastic ingots previously generated. This monetization requires the use of a collection apparatus capable of exchanging the ingots for credit, currency, promotions, or other commodity. In some embodiments, it may be desirable for such a centralized collection system to be community based, such as at a supermarket, or other convenient location for users. By centrally locating these collection and monetization apparatuses, the logistics involved in picking up the ingots is made economically feasible. However, it may also be possible, in some embodiments, to have residential type systems that enabled monetization at a more granular level.

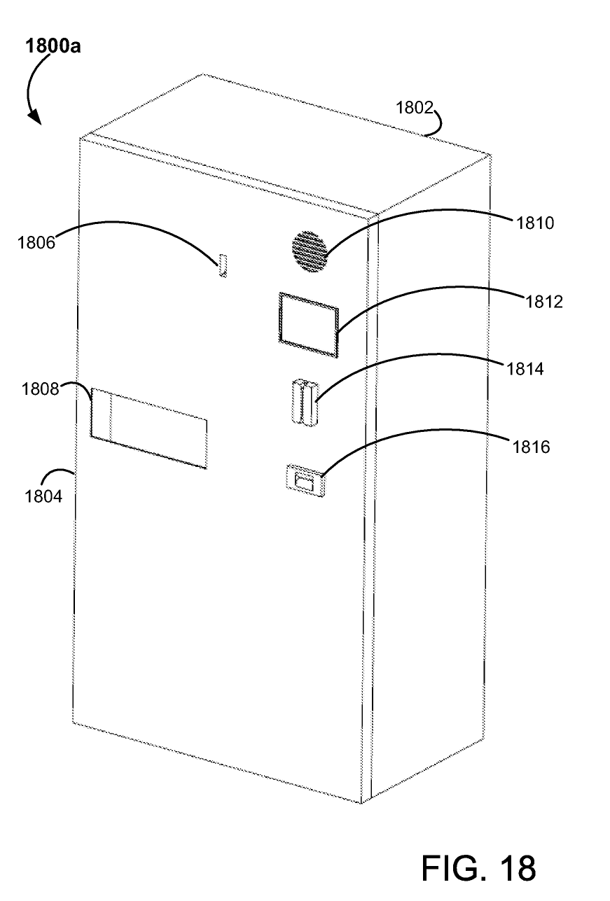

FIG. 18 is an isometric frontal view of a recyclable plastics monetization apparatus, shown generally at 1800a, in accordance with some embodiments. In this example embodiment, the monetization apparatus is a vending-like apparatus ideally suited to be placed in a shopping center, recycling center, schools, or other convenient location accessible by a user. The system may include an outside shell 1802, with the front of the monetization apparatus including a door 1804. The shell and door may be enabled to include advertisements, logos or other graphics. In some embodiments, external panels may readily be attached to the external surfaces of the apparatus to enable easy and rapid alteration of the appearance. This advertising may be helpful for public relations, and for offsetting unit costs. Additionally, some embodiments of the system may include solar power panels to make a truly “green” solution.

A number of subsystems are also visible on the door 1804. These include a speaker 1810 which is capable of providing audio instructions to the user. The speaker 1810 may be particularly helpful for enabling blind or otherwise visually impaired individuals with audio prompting on machine operation. Additionally, a display 1812 is illustrated to provide visual instructions and information. In some embodiments the display 1812 may be a touch screen for option selection and receiving user input. In some alternate embodiments a set of buttons may be provided for user input purposes. Although not illustrated, the door may include an e-wallet reader in order to interface with a mobile device to credit an account electronically using a smart phone or other device.

A magnetic reader 1814 is seen below the display 1812. The magnetic reader 1814 may enable reading of credit and debit cards' magnetic strip. This data may be utilized to credit a user's account for plastic deposits made. Alternatively, the system may instead use unique voucher cards which the magnetic reader 1814 may access instead. These voucher cards may be linked to the user by identification information, or may merely include a balance amount. These voucher cards may be retailer specific (such as a store gift card) or may be utilized in a wide variety of retail settings.

In some embodiments, instead of crediting the user a dollar amount for plastic deposited, a point based system may be introduced. Accumulation of points may be then expended by the user to get cash, airfare, travel benefits, or may be utilized on partnering online shopping websites. For example, in some embodiments, the user may deposit plastic ingots in order to collect points. These points are tied to a voucher card by swiping the card through the magnetic reader 1814. At home the user may log onto an online shopping partner (such as Amazon.com® for example) and shop for any item normally available for purchase. Then, at the checkout page the user may select an account tied to the voucher card for payment using “points” rather than traditional currency.

Point based vouchers have a number of benefits. For example, points may be redeemed at specific locations with licensed partners. From a business perspective this enables recovery of plastics without disbursement of funds directly to the user. This becomes in effect a short term loan to the monetization company until the points are expended and payment is due. Further, by partnering with wholesalers, users may trade points for retail value items. The wholesale price, plus some smaller margin, is paid by the monetization company to the retailer, thereby providing the greatest benefit to the user while minimizing payouts. Lastly, a point based system may also be used to adjust for commodity price swings of the plastic materials. This enables a user to receive a consistent number of points for an ingot of particular composition one week after the next. Point value may then be adjusted for plastic commodity fluctuations at the time they are used to pay for an item. In circumstances where a cash value is debited to the user's account, the amount received at one time for an ingot may be different a mere week later. For a user, it is more convenient, and has a better psychological effect, if the value gained from an ingot is perceived as consistent.

Below the magnetic reader 1814 is a dispenser 1816. The dispenser 1816 may provide new voucher cards for first time users, or users who have since misplaced their voucher card. Additionally, the dispenser 1816 may provide printed promotions (such as coupons or other offers), or dispense paper or coin money for users who do not wish to use a magnetic credit, debit or voucher card.

In some embodiments, when a new voucher card is provided to a user, they may be required to use the display 1812 and any related controls to provide identifying information which links the card to the individual. This has benefits in preventing fraud, as well as, ensured that users can still redeem their points or credit in the instance where the voucher is lost.

Although not illustrated, it is also possible that the monetization apparatus includes a smart phone interface. Smart phones may download an application that would enable the phone to function as a voucher card. The monetization apparatus would be able to access the phone and provide the proper points or credit into the users account via this interface.

The coin receptacle 1806 is where the user may insert the plastic ingot. In this following figures and paragraphs, particular attention will be paid to ingots that are coin shaped. This does not preclude the system from being designed to accept other ingot shapes and sizes; however, for the sake of clarity a coin based system is currently presented.

If a plastic ingot/coin is not accepted by the monetization apparatus, it may be rejected and expelled to the coin return 1808. The monetization apparatus has sophisticated mechanisms for determination of coin authenticity and fraud detection in order to ensure the plastic ingot market's fidelity. Coins that do not pass these validating measures may be expelled to the user via the coin return 1808 with accompanying explanation via the speaker 1810 and/or display 1812 on why the coin was rejected. For example, the system may indicate that a “bad coin” was inserted, or may indicate the “coin is unverified”.

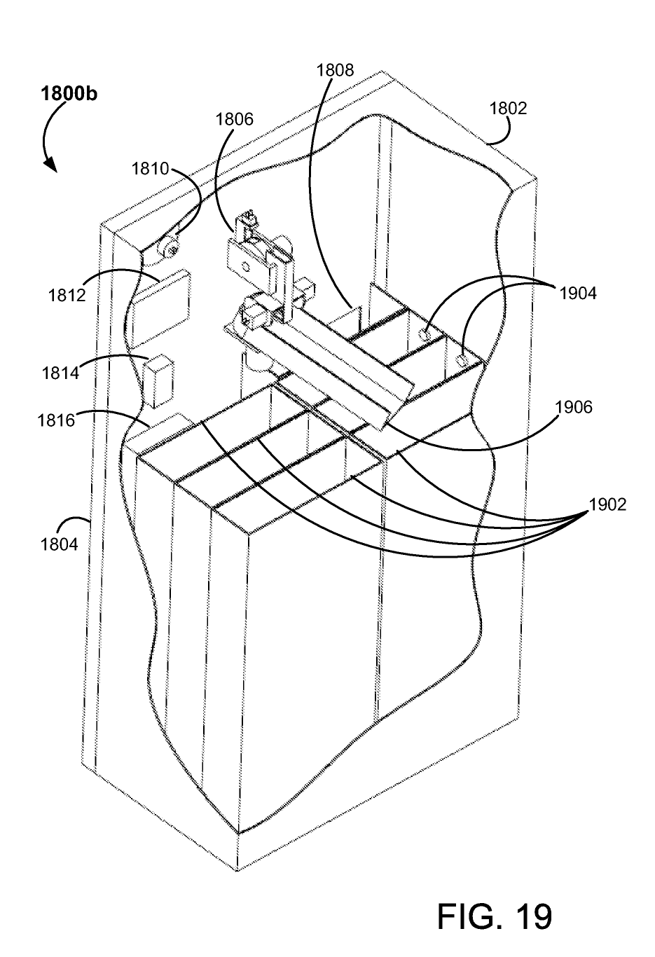

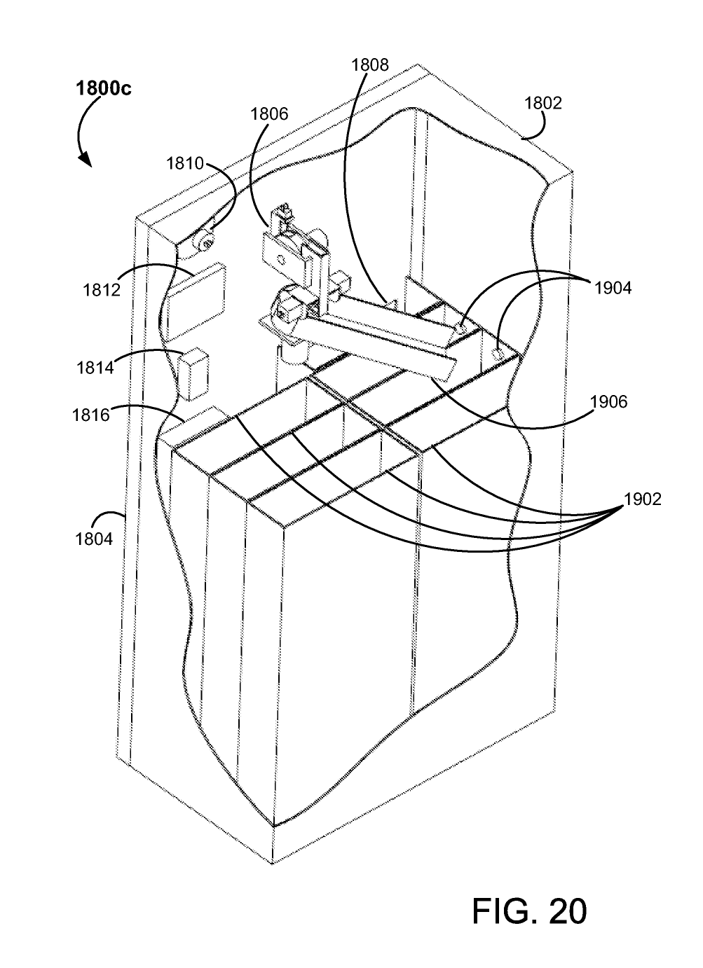

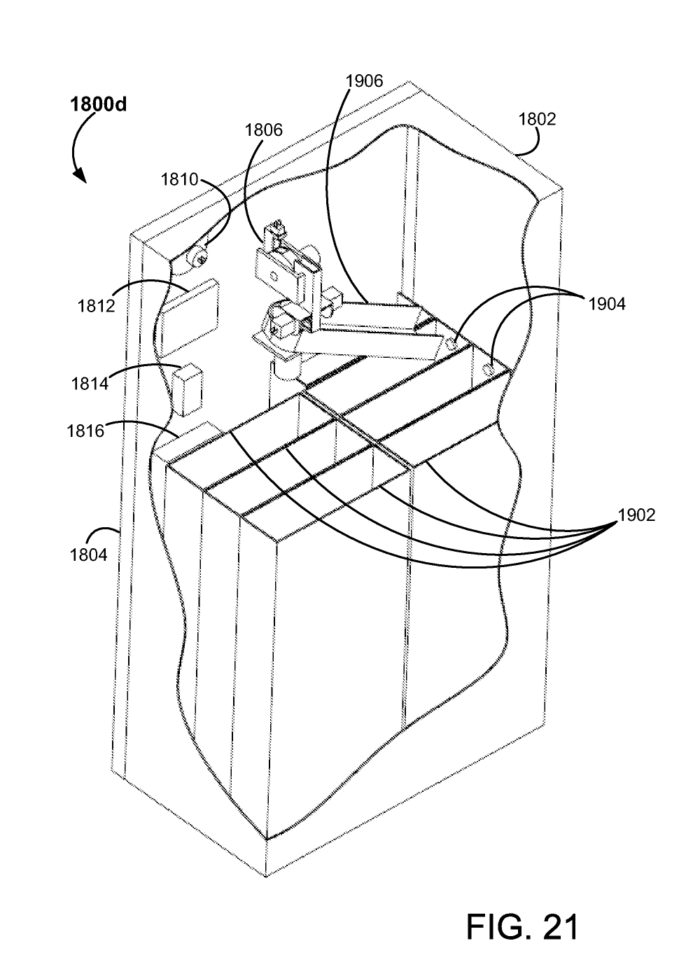

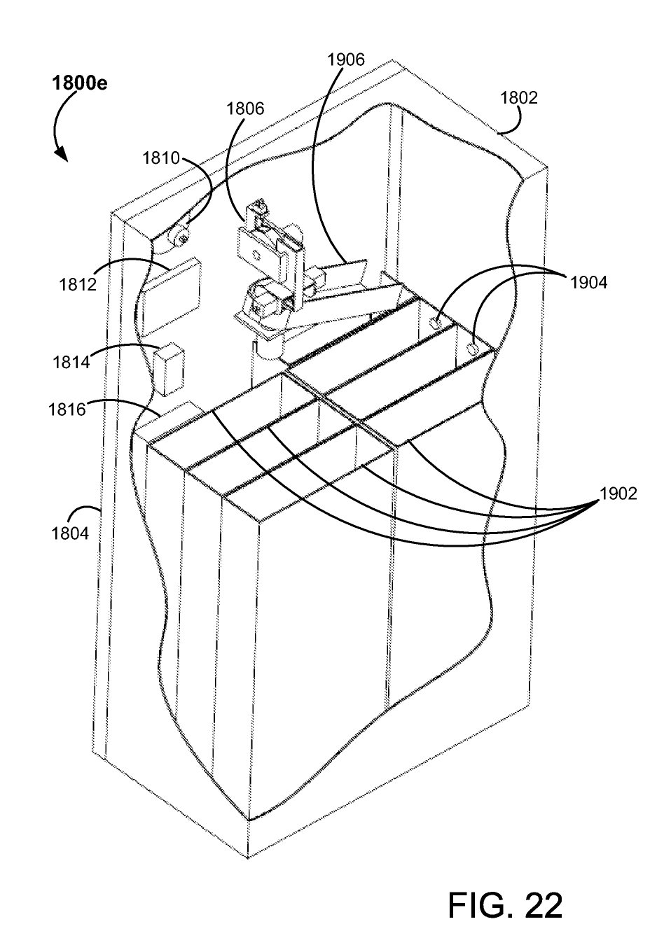

FIGS. 19 to 22 are isometric rear cutaway views of the recyclable plastics monetization apparatus illustrating example sorting positions, shown generally at 1800b to 1800e respectively, in accordance with some embodiments. In these example illustrations the components addressed previously are again visible, but this time they are visible from the interior of the monetization apparatus. This includes the cutaway outside shell 1802, the door 1804, speaker 1810, display 1812, magnetic reader 1814, dispenser 1816, coin return 1808 and coin receptacle 1806. As can be seen, the coin receptacle 1806 is significantly more complicated than was readily visible from exterior views. More detail related to the coin receptacle 1806 will be provided below. A number of electrical connections and other internal electronics and power supplies are omitted from these drawings as to not unnecessarily clutter the illustrations.

The coin receptacle 1806 couples to a ramp 1906. The ramp 1906 may swivel in order to deposit the ingots into any of the available containers 1902. Ingots may be made from mixed plastics or single plastic types. In some embodiments, the monetization apparatus is capable of differentiating what the ingot composition is prior to storage. Ingot value may vary depending upon composition, and generally like compositions will be collected into containers 1902 with other ingots of similar compositions. On each container 1902 is a sensor 1904 enabled to tell the system when the container 1902 is full. In some embodiments, each container 1902 may be designated for a particular ingot type. In some alternate embodiments, the system sorts different ingots into containers 1902, respectively. Once a container 1902 becomes full, the system may start a new container 1902 with that ingot composition. Thus, while six containers 1902 are illustrated, it is often the case that only three or four ingot types will be dealt with. In this way, a monetization apparatus which receives different numbers of each ingot composition due to the user base can accommodate the incoming ingots before completely filling up. This also enables less frequent pickups of the collected ingots.

These figures illustrate that the ramp 1906 is capable of swiveling in order to drop the ingot in any of the available containers 1902 as well as the coin return 1808. If an ingot/coin is unable to be verified, it may be desirous to reject the coin by dropping it into the coin return 1808. The user may then recover the coin.

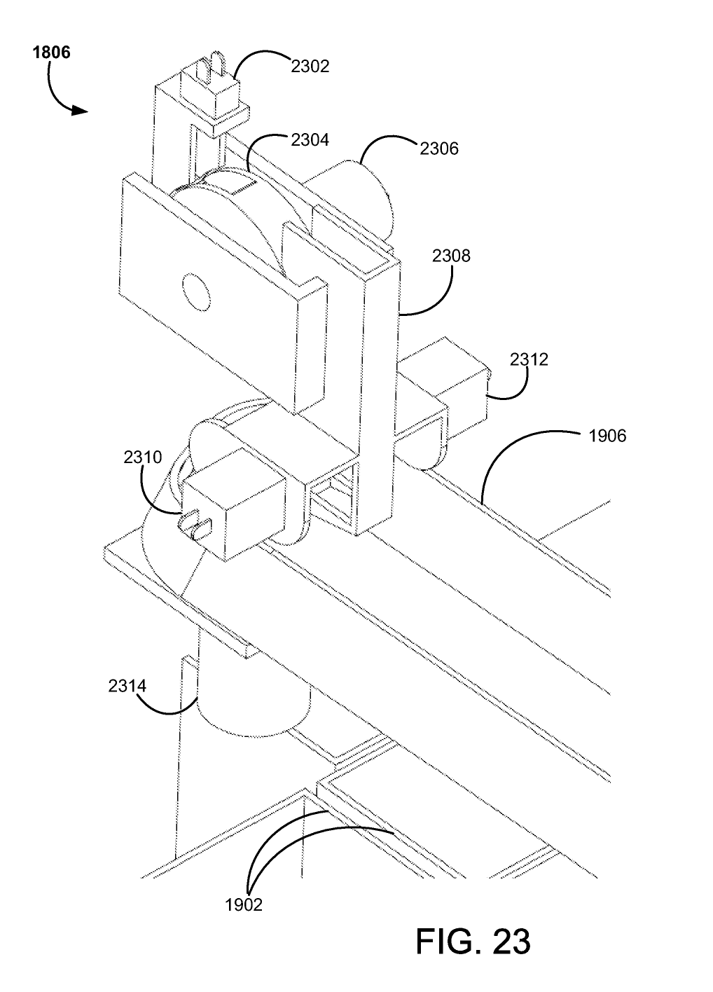

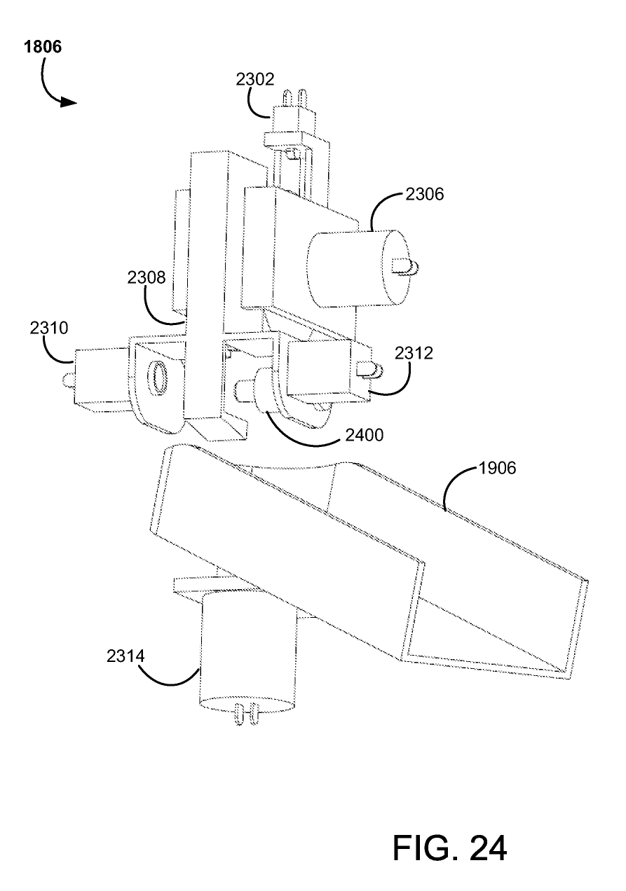

FIGS. 23 and 24 are isometric views of the coin receptacle 1806 of the recyclable plastics monetization apparatus, in accordance with some embodiments. The coin receptacle 1806 described in relation to these figures is designed to receive a plastic coin of known specifications. Other embodiments of the coin receptacle 1806 are also considered within the scope of this disclosure. These other coin receptacle 1806 may be configured to receive a wider range of ingots or different shaped or sized ingots. Such variants would be readily designed and implemented by one skilled in the art, and as such are omitted from this disclosure in the interest of clarity.

As previously noted in the section related to densification, the ingot coins generated are standardized by size, weight, and shape, dependent upon composition. In alternate embodiments, all coins, regardless of composition, are similarly sized and shaped, and identification of composition is provided by embossment or other marking. In either case, the monetization apparatus may be preloaded with the specifications related to these standardizations. This enables the machine to check for these attributes and therefore sort coins accordingly and further to identify coins that do not comport to the standards. These coins may have been improperly manufactured, or may even be counterfeit or fraudulent.

The coin receptacle 1806 first has a size sensor 2302 which is enabled to measure the diameter of the inserted coin. The coin then falls into a slot in a conveyer 2304. The conveyer 2304 may be utilized to transport the coin. Additionally, some embodiments of the conveyer 2304 may additionally measure coin shape and/or weight. The conveyer 2304 also ensures that only one coin is inserted at a time into the system. A motor 2306 drives the conveyer 2304 to ensure proper coin acceptance speed, thereby allowing each coin to be sorted into the appropriate containers 1902 before accepting another coin.

The coin may travel down the guide 2308 to a staging area. At the staging area the coin may be weighed (if not done at the conveyer 2304) as well as characterized using one or more sensors 2310 and 2312. A solenoid 2400 may hold the coin in place at the staging area while the coin is characterized and sorted.

The sensors 2310 and 2312 may include any number of applicable sensors in order to ensure coin validity. These may include optical sensors for reading identification embossed on the coin, barcode readers, and even an emitter on one side of the coin and an optical detector on the other side which measures wavelength absorption and transmission in order to characterize the coin composition.

The size of the coin, weight, shape and optical data may be compared against the standardizations stored in the monetization apparatus in order to determine the coin composition, and equally importantly, the coin's authenticity. If any one factor is not within an acceptable range according to the specification, it may be returned to the user as a “bad coin”. In some embodiments, the user may be presented with an option to not receive the coin back in exchange for some marginal value.

The ramp 1906 may swivel, as previously illustrated, so that the coin is deposited into the proper containers 1902 or the coin return 1808. A motor 2314 drives the rotation of the ramp 1906. Once the ramp 1906 is properly oriented, the peg of the solenoid 2400 is retracted, thereby allowing the coin to drop into the ramp 1906 and then slide into its final destination.

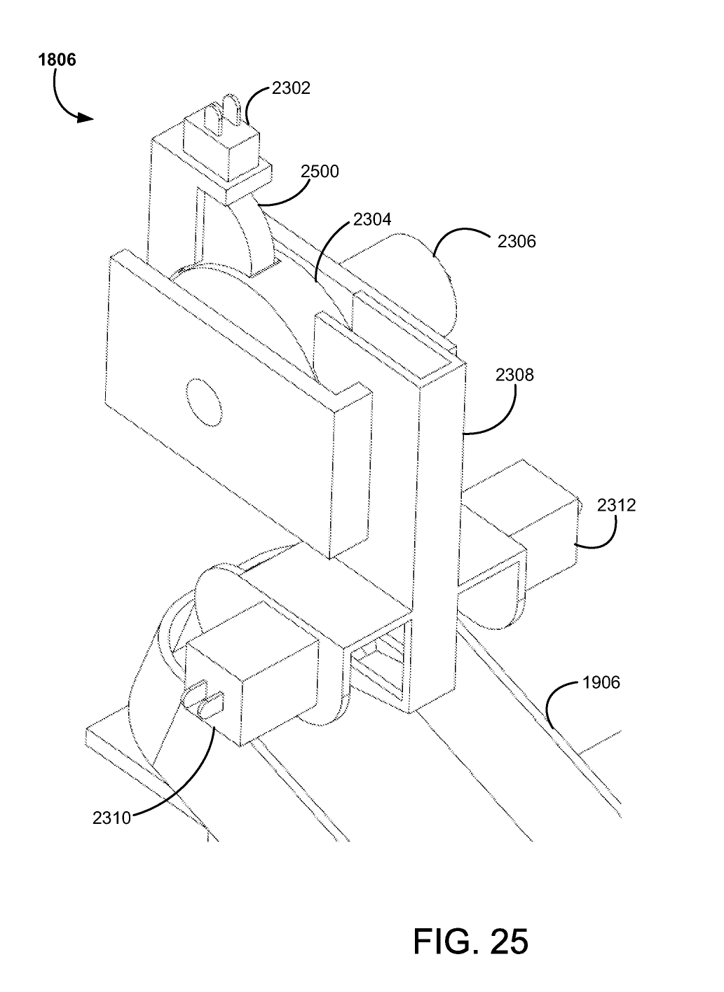

FIGS. 25 to 27 are isometric views of the receiving unit in conjunction with a fungitized coin 2500 at various stages of sorting, in accordance with some embodiments. At FIG. 25, the coin 2500 has just been inserted into the coin receptacle 1806. The coin 2500 engages the conveyer 2304 and size sensor 2302 which measures the size of the coin 2500, and optionally its shape and weight.

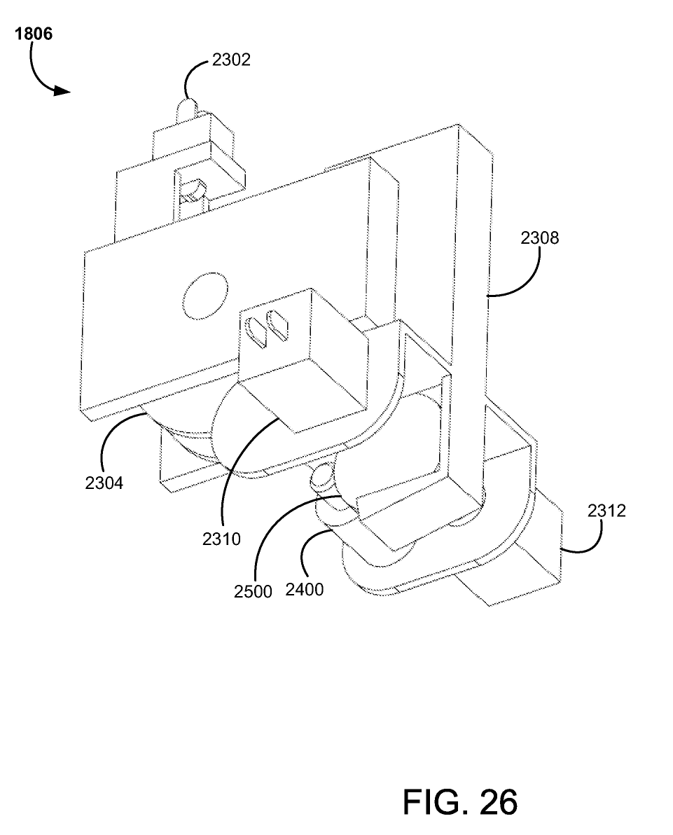

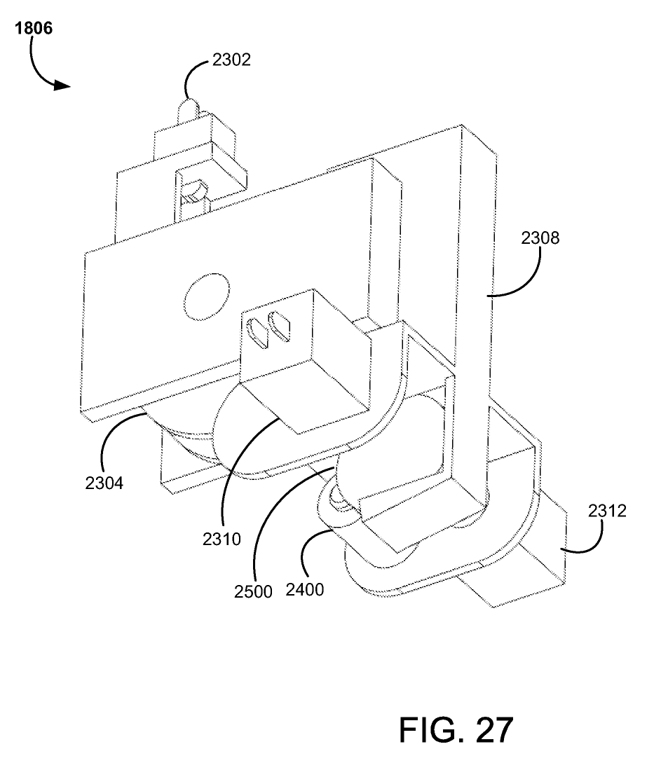

The conveyer 2304 then rotates allowing the coin 2500 to drop down the guide 2308 and land at a staging area, as illustrated at FIG. 26. The solenoid 2400 prevents the coin 2500 from going any further. Meanwhile the sensors 2310 and 2312 measure coin 2500 identification and/or optical properties. Weight may also be measured at this location. The weight, shape, size and/or optical data are compared to known standards to determine coin composition. The composition is used to properly sort the coin 2500, and award the user accordingly. Then the peg of the solenoid 2400 is retracted, as illustrated in FIG. 27, in order to allow the coin to drop down into the proper containers 1902.

In some embodiments, not all of weight, size, shape, identification reading, and optical properties are measured in order to characterize the coin 2500. In some embodiments, only the size and optical properties are utilized, for example. In other embodiments, maybe only size and weight are utilized to determine coin composition. Further, in some embodiments, additional composition tests may be employed to determine composition. These may include melt point detection, surface properties, specific heat measurements, thermal or electrical conductivity, or even chemical assays. The techniques utilized may be dependent upon fraud risk, cost and additional factors.

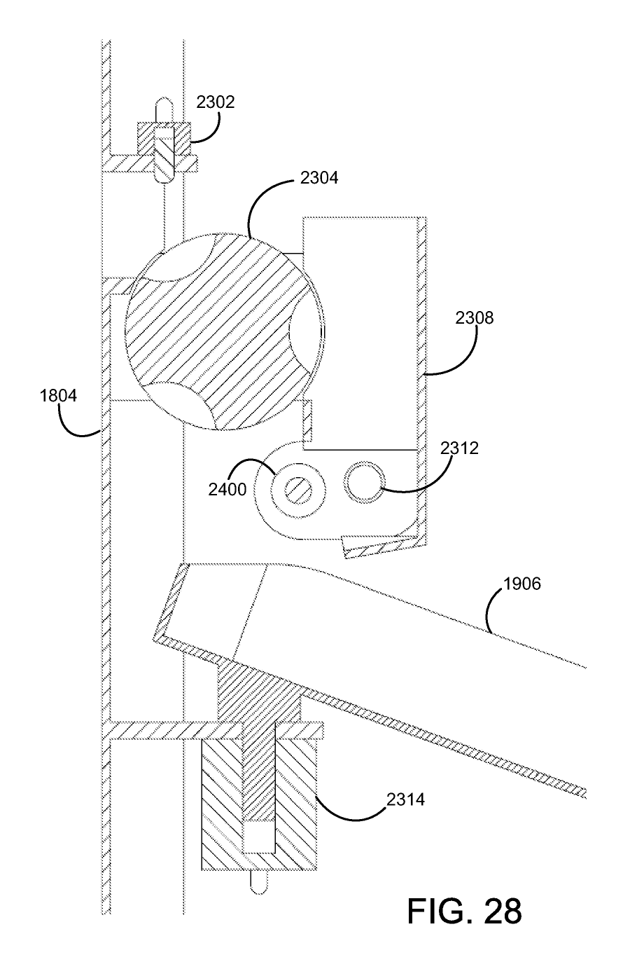

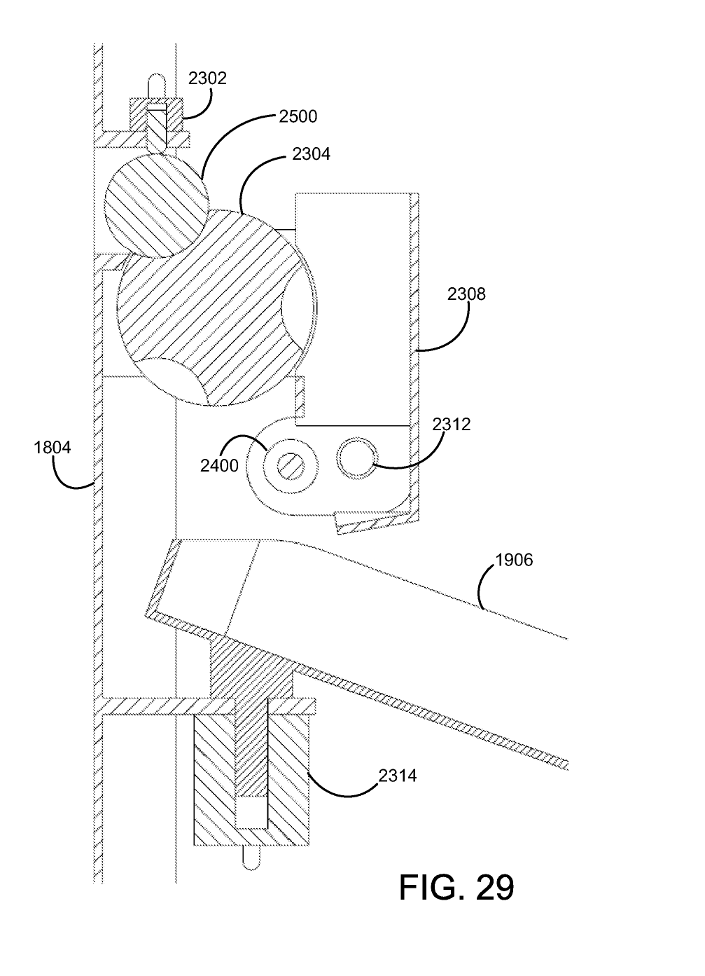

FIGS. 28 to 32 are side cutaway views of the coin receptacle 1806 in conjunction with a fungitized coin 2500 at various stages of sorting, in accordance with some embodiments. At FIG. 28, the system is illustrated as not in use. The view is a cutaway from the side, showing the door 1804 and coin receptacle 1806 on the interior of the monetization apparatus. At FIG. 29, a coin 2500 is inserted. The size sensor 2302 includes a spring mounted switch that measures the diameter of the coin 2500. The conveyer 2304 is illustrated as having numerous slots capable of receiving the coin 2500. These slots may include pressure sensors in order to determine the shape of the coin 2500, in some embodiments. Additionally, the conveyer 2304 may be mounted on a pressure sensitive manner to enable measuring the weight of the coin 2500, in some embodiments.

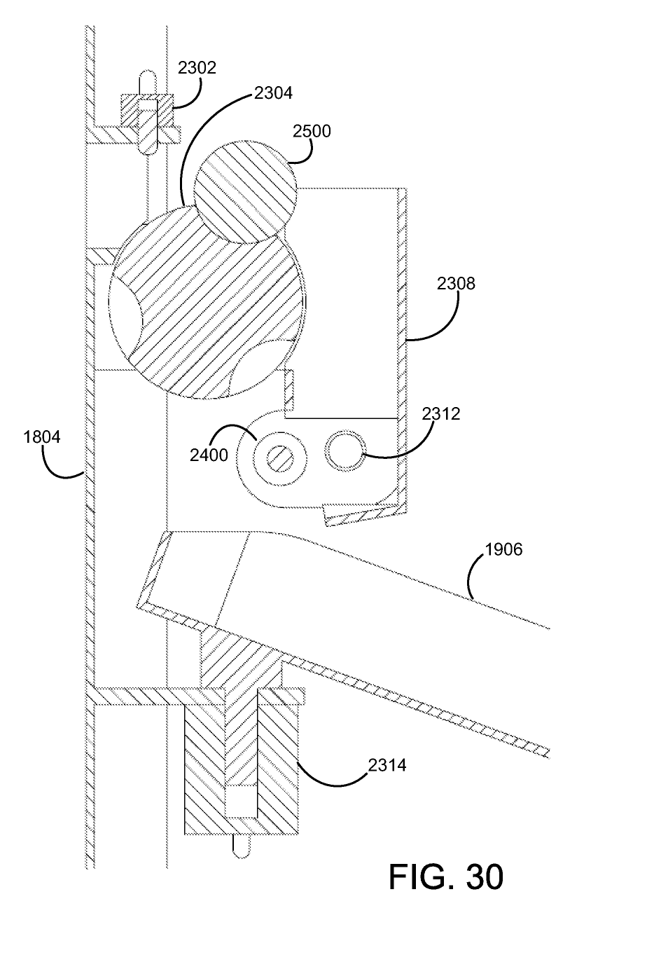

The conveyer 2304 rotates, as indicated at FIG. 30. As no slot is directed toward the opening, this restricts the user from inserting another coin until the system is ready to receive another coin.

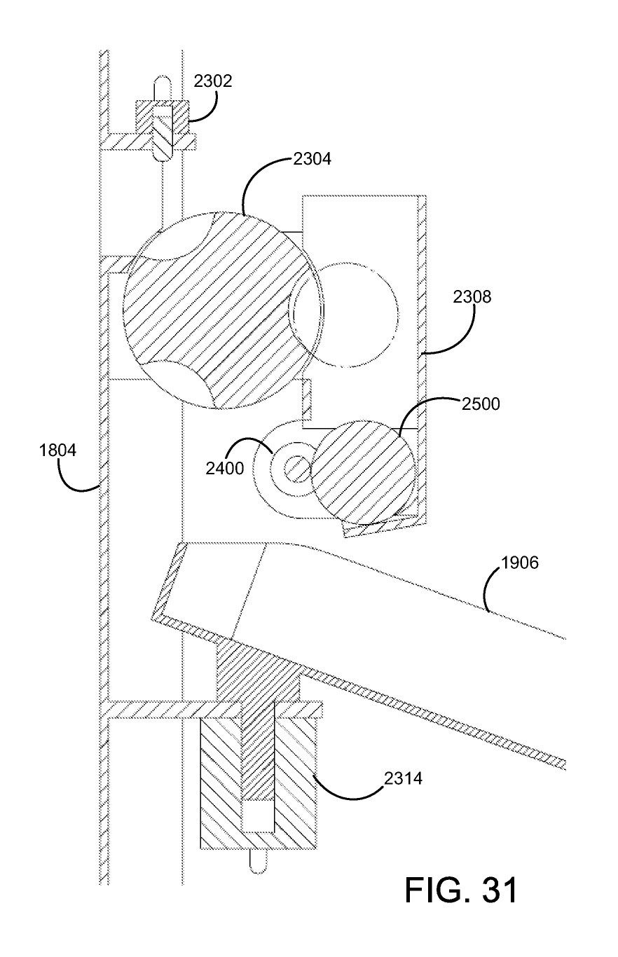

The coin 2500 then falls off of the conveyer 2304 and down the guide 2308 to a staging area, as indicated at FIG. 31. The coin 2500 is held in place by the peg of the solenoid 2400. One or more sensors 2310 and 2312 may then read the coin 2500 for identification, in some embodiments. In some alternate embodiments, the sensors 2310 and 2312 may measure optical properties of the coin 2500, including spectroscopy measurements, or any other desired measurements (thermal, chemical electrical, etc.). The various measurements of the coin 2500 may then be compared against allowable ranges to determine if the coin 2500 is acceptable, and further which of the containers 1902 it should be sorted into, and conversely how much the user should be rewarded for the coin 2500.

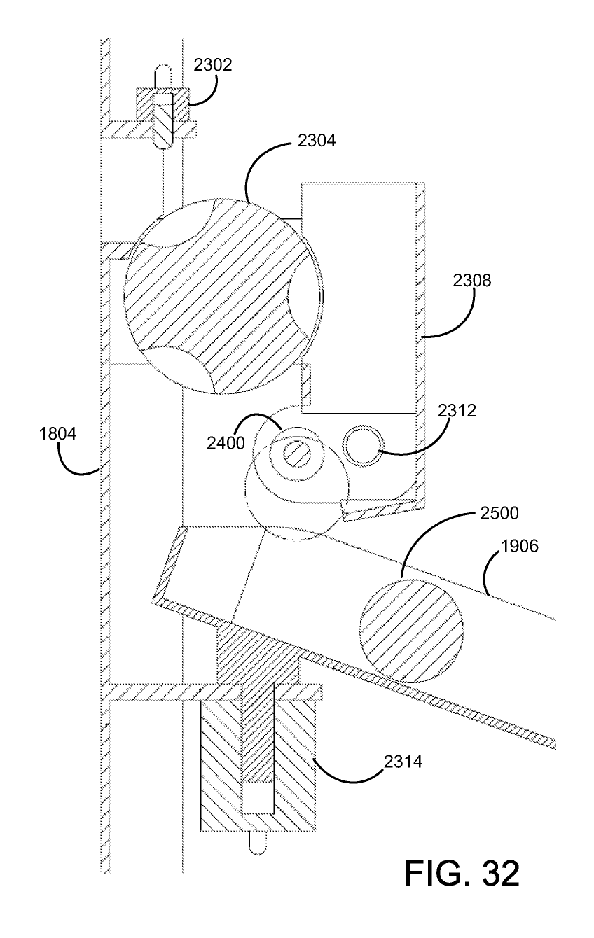

The motor 2314 then rotates the ramp 1906 such that it is aimed at the appropriate container 1902 (or coin return 1808). The peg of the solenoid 2400 then retracts, thereby allowing the coin 2500 to drop down the ramp 1906, as illustrated at FIG. 32.

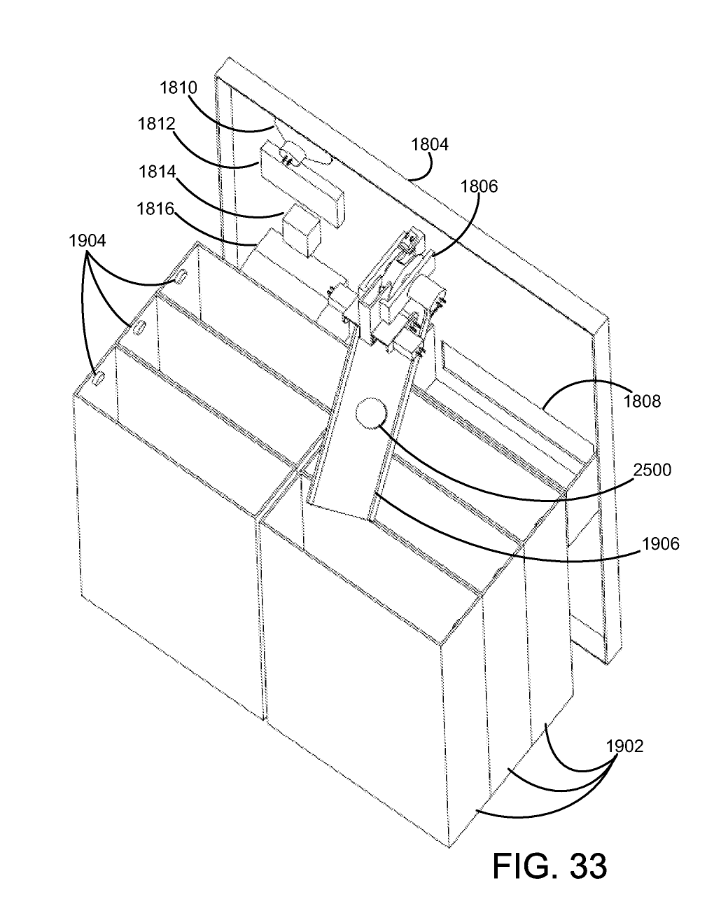

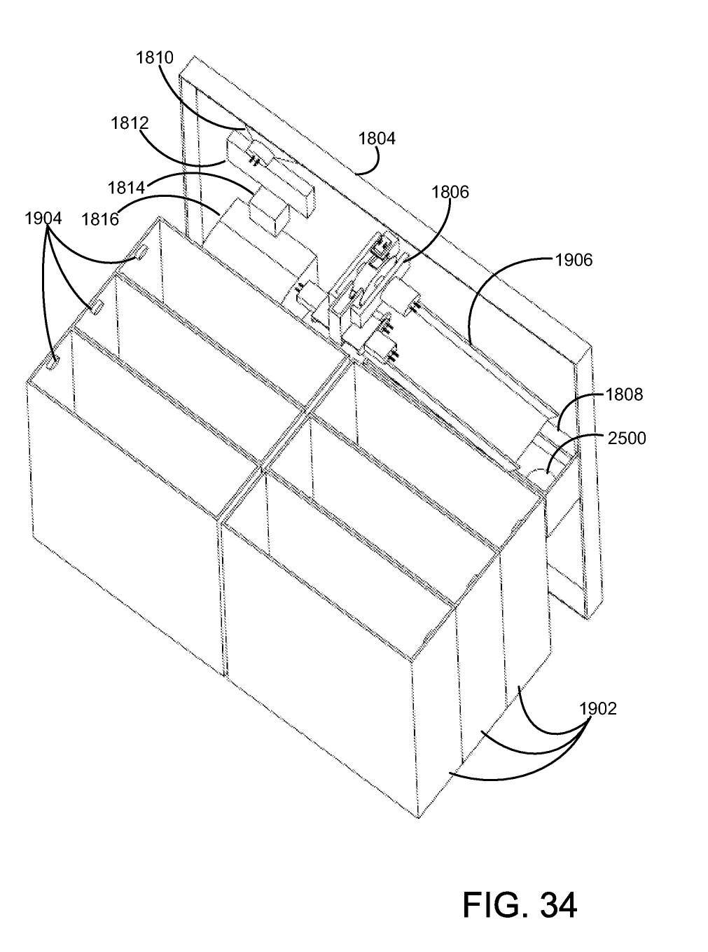

FIG. 33 is a rear isometric view of the interior of the recyclable plastics monetization apparatus in conjunction with a fungitized coin 2500, in accordance with some embodiments. In this figure, the coin 2500 was found acceptable and is being deposited into one of the containers 1902. Conversely, in FIG. 34, the coin 2500 was found unacceptable, and is therefore being deposited into the coin return 1808.

In addition to being able to identify coins which do not comport to standardized specifications, the monetization apparatus may also be capable of communication over a network, such as the internet, with a central server. This server may utilize the user information accessed via the voucher card, credit card or smart phone application to identify past fraudulent behaviors. This data may be utilized to ensure the densification machine the user is using is serviced, or may indicate an individual who is purposefully counterfeiting coins in order to gain credits or points. Coins from these individuals may be automatically rejected, or may be sorted separately to enable further review or testing. Crediting on these users accounts may be subjected to a hold, pending coin verification, as well.

In addition to reducing fraudulent activity, the communication with a server may enable saving user information in relation to a voucher card or other account data. Additionally, user activity may be tracked and additional promotions/loyalty programs may be implemented. Further, the communications can indicate when the monetization apparatus is approaching capacity, and collection is needed.

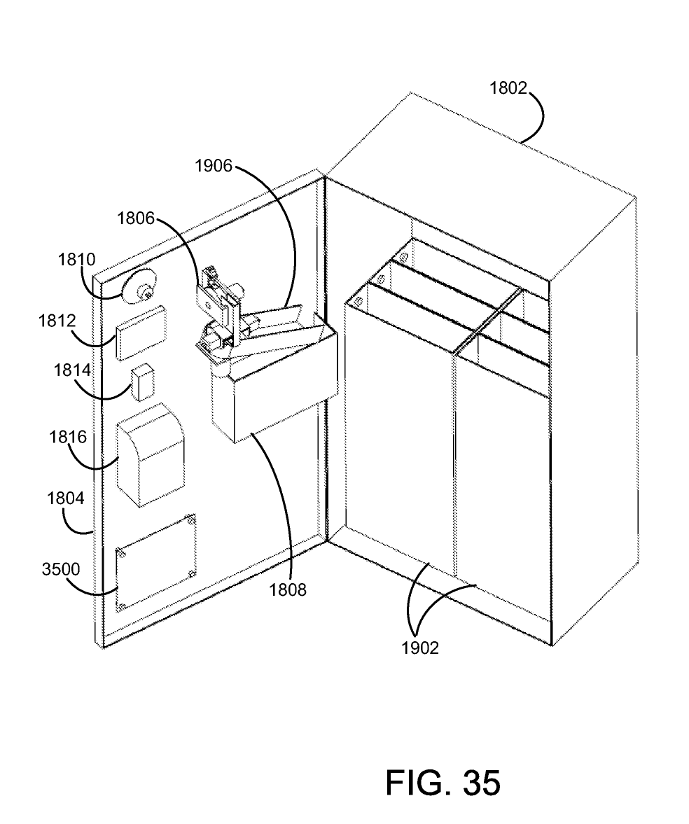

FIG. 35 is a front isometric view of the recyclable plastics monetization apparatus with the door 1804 open, in accordance with some embodiments. The door 1804 may be securely locked in order to prevent vandalizing of the machine, or theft of coins, money, or voucher cards. In some embodiments, the door 1804 may be opened only by authorized personnel who have the appropriate key or access code. Opening the door 1804 enables collection of the sorted coins. In some embodiments, the containers 1902 may be modular and therefore may be removed and simply replaced with new empty containers 1902. This enables faster pickup of the collected coins.

Additionally, a control circuitry 3500 is visible in this illustration. The control circuitry 3500 may include network connectivity, memory, and one or more processors capable of controlling the systems of the monetization apparatus, and performing the necessary calculation to determine coin value and composition.

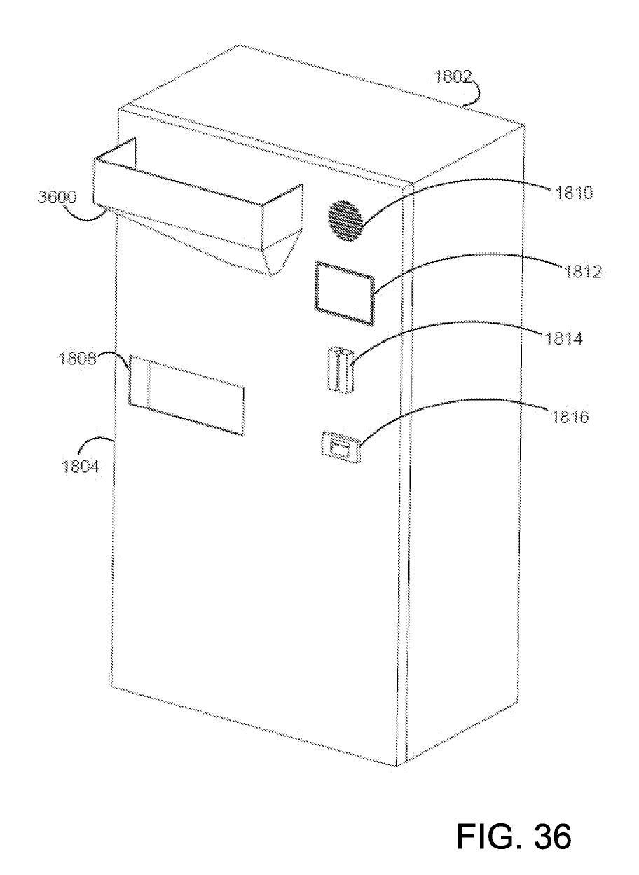

FIG. 36 is a front isometric view of another embodiment of the recyclable plastics monetization apparatus, in accordance with some embodiments. This figure is but one example of the many possible embodiments of such systems. In this example figure, the majority of components previously identified are also present, with one marked exception: a coin hopper 3600 is present on the top of the monetization apparatus. The coin hopper 3600 may enable a user to drop a number of coins in at one time. The monetization apparatus will individually accept and sort the coins until the coin hopper 3600 is empty. This enables users to return a number of coins more easily.

Other embodiments, not illustrated, are also considered within the scope of some embodiments. In some embodiments, for example, the monetization apparatus may be able to receive a magazine that holds a plurality of plastic ingots, and may empty the magazine and verify the ingots' authenticity. The magazine could then be returned to the user for subsequent use. In some other embodiments, the monetization apparatus may be enabled to receive a container of densified plastic shreds. The container may be emptied using an appropriate coupler, and the shreds may be weighed (or volume measured) in order to determine value. Likewise, vacuum packed pouches of plastic fragments could likewise be received, weighed, and value returned to the user.

In another embodiment, some systems may also include an identifying scanner and bottle receptacle. In these embodiments, the user may scan a drink bottle and the monetization apparatus may then accept the bottle and credit back the user the recycle value. In regions with redemption values attached to beverage containers, the user may be credited this value at the time of collection. Bottles collected into the monetization apparatus may be compacted and stored in a bottle container. In some embodiments, the system could weigh the incoming bottle to ensure it is empty, and reject any nonconforming bottles.

Alternate embodiments may also include a vacuum port for receiving plastic bags and wrappings. Additionally, in some embodiments, the monetization apparatus may include a densification apparatus as described above. In these embodiments, the user could insert coins, as described above, or could insert bottles and bags that would be densified, and value provided to the user instantaneously. Alternatively, in some embodiments, bottles may be invertible into the system which can then compact the bottles using mechanical means (i.e., crushing, shredding, etc.) without fully densifying the material.

In yet other embodiments, the monetization apparatus may be built in conjunction with a vending machine. For example, Coke® may wish to increase its “green” image and therefore partner to have Coke® vending machines with the monetization apparatus conjoined. This has a number of benefits relating to distribution infrastructure leveraging. Currently, vending machines are already serviced regularly to restock the consumed goods. The collected bottles or plastic ingots could be easily collected simultaneously, thereby increasing collection efficiency. Additionally, bottles inserted into the monetization apparatus could have their value applied directly to the purchase of a new beverage form the vending machine. This incentivizes users to make an additional purchase, thereby increasing sales of the vending machine.

Likewise, in some embodiments, the monetization apparatus may be coupled to a trashcan. Such systems could be installed in a fast food restaurant, school or stadium, for example. The combined monetization apparatus and trashcan would incentivize users who are discarding their waste to sort the plastics prior to discarding their trash.

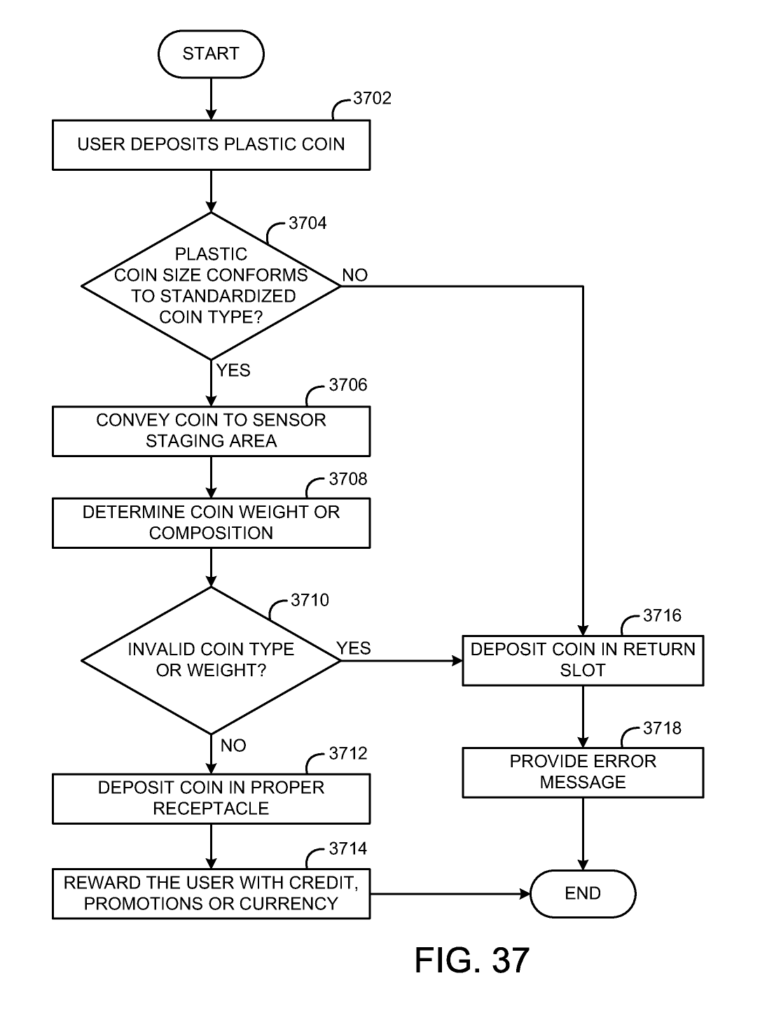

FIG. 37 is an example flow chart illustrating a method for the monetization of recyclable plastics, in accordance with some embodiments. In this example process, a user deposits a plastic coin or ingot (at 3702) into the monetization apparatus. A determination is made on whether the coin is of a standardized size and shape (at 3704) by size exclusion of the opening and diameter measurements. If the coin is not standardized sizing, it may be unable to fit into the system, or may pass through to the return slot (at 3716) along with an error message to the user (at 3718).

Otherwise, if the coin shape and size are correct, it may be conveyed to the staging area (at 3706) for sensor analysis. The sensors may determine coin weight, composition or both (at 3708). Composition may be determined through reading of identification, optical properties, or other assays such as thermal, electrical, or chemical. The system then determines if the coin is authentic by comparing the size, weight and/or composition data against standardized ranges (at 3710). If the coin is fraudulent, it may be deposited into the return slot (at 3716) along with an error message to the user (at 3718).

Otherwise, the composition or identification data may be utilized to deposit the coin in the proper container with like composition coins (at 3712). The user may be rewarded with credit, promotions or cash (at 3714) according to the coin's value determined by composition. The process is then concluded.

In sum, the present invention provides systems and methods for monetization of recyclable plastics. Such systems and methods enable the generation of a marketplace for fungible and standardized plastic ingots, thereby simplifying collection of the plastics, and providing incentives for increased recycling.

While this invention has been described in terms of several embodiments, there are alterations, modifications, permutations, and substitute equivalents, which fall within the scope of this invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for monetization of recyclable plastics comprising:
densifying a plastic, wherein the densification of the plastic includes reducing the plastic into dimensionally smaller plastic fragments and compacting the smaller plastic fragments to reduce volume;
fungitizing the densified plastic, wherein the fungitizing includes molding the plastic fragments into at least one standardized form corresponding to at least one known value;
recognizing the fungitized densified plastic form;
accepting the fungitized densified plastic form; and
rewarding a user for depositing the recognized fungitized densified plastic form.

2. The method as recited in claim 1, wherein the fungitized plastic is a plastic ingot of specific shape, size, weight and composition.

3. The method as recited in claim 2, wherein recognizing the fungitized plastic includes comparing the shape, size, weight and composition of the plastic ingot to a range of standards.

4. The method as recited in claim 3, wherein the rewarding is based upon weight and composition of the plastic ingot.

5. The method as recited in claim 3, wherein the plastic ingot is recognized as a counterfeit if it fails to comport to the range of standards.

6. The method as recited in claim 3, further comprising sorting the recognized plastic ingot with plastics of like composition.

7. The method as recited in claim 1, wherein the rewarding includes crediting an account associated with the user.

8. The method as recited in claim 7, wherein the crediting the account includes crediting currency for the market value of the plastic minus a margin.

9. The method as recited in claim 7, wherein the crediting the account includes crediting points.

10. The method as recited in claim 1, wherein the rewarding includes providing promotions to the user.

11. A method for monetization of recyclable plastics comprising:
recognizing at least one standardized fungitized densified plastic form which corresponds to at least one known value;
accepting the fungitized densified plastic form; and
rewarding a user for depositing the recognized fungitized densified plastic form.

12. The method as recited in claim 11, wherein the fungitized plastic is a plastic ingot of specific shape, size, weight and composition.

13. The method as recited in claim 12, wherein recognizing the fungitized plastic includes comparing the shape, size, weight and composition of the plastic ingot to a range of standards.

14. The method as recited in claim 13, wherein the rewarding is based upon weight and composition of the plastic ingot.

15. The method as recited in claim 13, wherein the plastic ingot is recognized as a counterfeit if it fails to comport to the range of standards.

16. The method as recited in claim 13, further comprising sorting the recognized plastic ingot with plastics of like composition.

17. The method as recited in claim 11, wherein the rewarding includes crediting an account associated with the user.

18. The method as recited in claim 17, wherein the crediting the account includes crediting currency for the market value of the plastic minus a margin.

19. The method as recited in claim 17, wherein the crediting the account includes crediting points.

20. The method as recited in claim 17, further comprising networking with a server in order to link the user and the account with recycling activity.

21. The method as recited in claim 11, wherein the rewarding includes providing promotions to the user.

22. A system for monetization of recyclable plastics comprising:
a receptacle configured to receive fungitized plastic having a standardized form, wherein the fungitized plastic has a known value and is readily exchangeable for at least one of credit, discounts, and currency;
sensors configured to identify the fungitized plastic as substantially comporting to the standardized form; and
a crediting system configured to reward a user for depositing the recognized fungitized plastic.

23. The system as recited in claim 22, wherein the fungitized plastic is a plastic ingot of specific shape, size, weight and composition, and wherein the sensors identify the ingot by comparing the shape, size, weight and composition of the plastic ingot to a range of standards.

24. The system as recited in claim 23, wherein the crediting system bases the reward upon weight and composition of the plastic ingot, and wherein the reward is at least one of currency for the market value of the plastic minus a margin, and points.

25. The system as recited in claim 22, wherein the sensors are further configured to identify the fungitized plastic as counterfeit if it fails to substantially comport to the standardized form.

26. The system as recited in claim 22, further comprising a network adapter configured to communicate with a server in order to link the user with an account that tracks recycling activity.

27. The system as recited in claim 22, further comprising a sorter configured to collect the recognized fungitized plastic with other plastic of similar composition, and a solar collector configured to provide energy to the system.

28. A recyclable plastics monetizator comprising:
a recognizer configured to identify at least one molded standardized fungitized densified plastic form which corresponds to at least one known value;
a receptacle configured to accept the fungitized densified plastic form; and
a processor configured to reward a user for depositing the recognized fungitized densified plastic form.

29. The monetizator of claim 28 wherein the reward is at least one of credit, discount and currency.

30. The monetization method of claim 11 further comprising storing the fungitized densified plastic form in a standardized container.
